(19) United States
(12) Patent Application Publication
(10) Pub. No.: US 2025/0381663 A1
(43) Pub. Date: Dec. 18, 2025

(54) ROBOT DEVICE FOR UNLOADING CARGO AND CONTROL METHOD THEREOF

(71) Applicant: KOREA INSTITUTE OF INDUSTRIAL TECHNOLOGY, Cheonan-si (KR)

(72) Inventors: Kwang Hee LEE, Hanam-si (KR); Dong Bum Pyo, Gwangmyeong-si (KR); Jung San Cho, Yongin-si (KR); Hyun Su Kim, Suwon-si (KR); Yong Hyeon Song, Suwon-si (KR)

(21) Appl. No.: 19/313,663

(22) Filed: Aug. 28, 2025

Related U.S. Application Data
(63) Continuation-in-part of application No. PCT/KR2024/011533, filed on Aug. 5, 2024.

(30) Foreign Application Priority Data
Sep. 12, 2023 (KR) 10-2023-0120870

(51) Int. Cl. B25J 9/16; B25J 15/10; B65G 61/00

(52) U.S. Cl. CPC B25J 9/1612; B25J 9/1697; B25J 15/106; B65G 61/00

(57) ABSTRACT

An effector includes a body plate and at least one rod coupled to the body plate. The at least one rod is configured to be variably tilted with respect to the body plate. A robot device includes an end effector, a joint arm coupled to the end effector and configured to move the end effector, and a processor configured to execute a program stored in a memory so as to control movement of the end effector. The processor acquires cargo image information, controls the joint arm to perform a first movement so as to move the end effector above a cargo elevation, controls the joint arm to perform a second movement so as to move the end effector downward after the first movement, and controls the joint arm to perform a third movement so as to retract the end effector after the second movement.

### CROSS-REFERENCE TO RELATED APPLICATIONS

This application is a continuation-in-part of International Patent Application No. PCT/KR2024/011533, filed Aug. 5, 2024, and designating the United States, which claims priority under 35 U.S.C. § 119 (a) to Korean Patent Application No. 10-2023-0120870, filed Sep. 12, 2023. The entire contents of the foregoing applications are incorporated by reference in their entireties.

### TECHNICAL FIELD

Embodiments of the present disclosure relates to a robot device and a method of controlling the same, and more particularly, to a robot device for unloading cargo and a method of controlling the same.

### BACKGROUND

Logistics refers to the efficient flow of goods and encompasses the entire process from production and shipment to transportation, unloading, packaging, and storage. Although the methods of logistics are not particularly limited, most goods today are transported by vehicles, ships, or aircraft. For this, it is first desirable to load the goods into a loading space, such as a container, at the departure point and then to unload them from the loading space at the destination.

Since logistics is a factor directly reflected in the production cost of products, various efforts are being made to build a more efficient logistics system. In particular, as the scale and importance of the logistics industry have greatly increased in recent years, various studies are being conducted on technologies for the automation or semi-automation of loading, unloading, and transport of cargo.

In general, unloading in a broad sense may refer to the series of actions and activities involved in removing goods from a loading space and distributing them from a logistics hub to sub-hubs or delivering them to a final destination. In contrast, unloading in a narrow sense may refer to the process of removing goods from the loading space and placing them onto a telescopic conveyor. The unloaded goods may then be transferred along the telescopic conveyor as part of the process of being distributed to sub-hubs.

Conventionally, unloading in the narrow sense as described above has generally relied on human labor. However, manually unloading products may be demanding.

### SUMMARY

Embodiments of the present disclosure aim at providing a robot device for unloading cargo in a novel manner different from conventional methods.

It is another objective of the present disclosure to provide a method of controlling a robot device for unloading cargo.

It is still another objective of the present disclosure to provide a computer program recorded on a storage medium for performing the method.

It is still another objective of the present disclosure to provide a storage medium storing a program for performing the method or a device including the storage medium.

It is yet another objective of the present disclosure to provide a method of unloading cargo using the robot device.

Various objectives of the present disclosure are not limited to the above-described objectives, and other objectives not explicitly mentioned may be understood by those skilled in the art in light of the present disclosure.

In accordance with an aspect of the present disclosure, the above and other objectives can be accomplished by the provision of a robot device, including: a body plate; and at least one rod mechanically connected to the body plate, wherein the rod is configured to be variably tilted with respect to the body plate.

One side in a horizontal direction of the body plate may have a groove, and the rod may be disposed in the groove.

Coupling between the rod and the body plate may be a direct or indirect free coupling and may be configured to be tilted by gravity or an external force.

The rod may be provided as a plurality of rods, and tilting of each of the rods may be mutually independent.

The robot device may be for cargo unloading, the rod may be provided as a plurality of rods, and at least some of the plural rods may be configured to be insertable into gaps between individual cargo items on a cargo upper end.

In some embodiments, the robot device may further include: a guide rail disposed on the body plate; and a carriage configured to be movable along the guide rail and having a rod hole into which the rod is inserted.

The guide rail may include a first rail part extending in a first direction, and a second rail part extending in a third direction and connected to the first rail part.

The carriage may include guide blocks engaged with the guide rail, at least two guide blocks including a first guide block and a second guide block may be inserted into the guide rail, in a state, the first guide block and the second guide block may be both positioned in the first rail part, and in a state where the carriage is partially moved, at least one of the plural guide blocks may be positioned in the second rail part.

One side of the body plate in the first direction may have an indented groove, and the carriage may be configured to be at least partially linearly movable in the first direction while moving along the guide rail.

During tilting of the rod, the rod may be configured to be at least partially linearly movable in a direction intersecting an extension direction of the rod.

In some embodiments, the robot device may further include an elastic member fixed to the body plate and the carriage.

In accordance with another aspect of the present disclosure, provided is a robot device, including a processor configured to execute a program stored in memory, wherein the processor is configured to: acquire cargo image information; perform a first movement to move an end effector, which includes a body plate and rod of the robot device, above a cargo elevation; perform a second movement to move the end effector downward after the first movement; and perform a third movement to retract the end effector after the second movement.

The height of the body plate in the third movement to retract the end effector may be substantially the same as the height at the end of the second movement to retract the end effector.

In accordance with still another aspect of the present disclosure, provided is a method for unloading cargo, including: preparing a robot device including a body plate and a rod mechanically connected to the body plate; moving the rod above a cargo on which individual cargo items are loaded; moving the end effector downward; and retracting the end effector.

As a result of the moving of the end effector downward or the retracting of the end effector, at least a portion of the rod may be inserted between boundaries of individual cargo items.

During the retracting of the end effector, a lower end of the rod may retract while being in contact with an upper surface of the cargo.

At least a portion of the rod may be tilted during the retracting of the end effector.

During the retracting of the end effector, at least a portion of the rod may move in a horizontal direction.

As a result of the retracting of the end effector, at least a portion of the cargo may be swept and unloaded by the rod.

Specific details of other embodiments are included in the detailed description.

According to embodiments of the present disclosure, even when cargo units are loaded in an irregular and misaligned state with non-uniform sizes and shapes, at least one rod can be inserted through gaps between the cargo units (or cargo items) from the upper front surface (or a portion of the upper surface) thereof, and cargo can be unloaded by sweeping them using the rod.

In particular, because the rod is freely coupled to an end effector and its downward protrusion length can be varied by external force, the rod can be effectively inserted into gaps between cargo units even when the upper front surface of the cargo is uneven.

Furthermore, the rod is configured such that its tilting degree, i.e., the inclination, can vary according to external forces. This can prevent an excessively heavy load to be unloaded at once from being applied to the rod, and can allow the load applied to the end effector by the cargo to be estimated. Through the above-described free tilting structure, damage to the robot device during the sweeping-based unloading process can be substantially prevented in advance, as well as damage to the cargo.

The effects of the embodiments of the present disclosure are not limited to the examples described above, and various additional advantages are included throughout this disclosure.

### BRIEF DESCRIPTION OF DRAWINGS

FIG. 1 illustrates a hardware configuration diagram of a robot device according to an embodiment of the present disclosure.

FIG. 2 illustrates a perspective view of the robot device of FIG. 1 according to an embodiment.

FIG. 3 illustrates a logical block diagram of the robot device shown in FIG. 1 according to an embodiment.

FIG. 4 is a perspective view illustrating an end effector of the robot device in FIG. 2.

FIG. 5 illustrates an enlarged view of area A in FIG. 4.

FIG. 6 is an exploded perspective view of the end effector in FIG. 5.

FIG. 7 is a flowchart illustrating a control method of the robot device according to an embodiment of the present disclosure.

FIGS. 8, 9, 10, 11, 12, 13, and 14 are schematic diagrams illustrating a process of unloading cargo using the robot device according to an embodiment.

FIGS. 15, 16, 17, 18, 19, 20, 21, 22, and 23 are schematic diagrams illustrating a process of unloading cargo using the robot device according to an embodiment.

FIG. 24 illustrates a perspective view of an end effector according to another embodiment of the present disclosure.

FIG. 25 illustrates an enlarged view of a region A of FIG. 24.

FIG. 26 illustrates an exploded perspective view of the end effector of FIG. 25.

FIGS. 27, 28, and 29 are schematic diagrams illustrating a tilting process of a rod of an end effector of FIG. 24, according to an embodiment.

FIG. 30 is an enlarged view of a portion of an end effector according to another embodiment of the present disclosure.

FIG. 31 is an exploded perspective view of the end effector of FIG. 30.

FIG. 32 is a side view of the end effector of FIG. 30.

### DETAILED DESCRIPTION

Beneficial aspects and features of the present disclosure, and the method of achieving them, will become more apparent from the embodiments described in detail below with reference to the accompanying drawings. However, various embodiments of the present disclosure are not limited to the embodiments disclosed herein and may be embodied in various other forms.

Furthermore, the claims are not intended to describe the technical details that constitute the substance of the disclosure, but rather to define the scope of rights claimed. If those skilled in the art can understand, based on the specification, the technical composition, combinations, and effects claimed, then the claims are deemed to be supported by the detailed description of the disclosure.

That is, various modifications may be made to the embodiments disclosed in the present disclosure. The following embodiments are not intended to limit the form of implementation, and various modifications, equivalents, or substitutions thereof are to be understood as being included in embodiments of the present disclosure.

If any term used in this specification is intended to have a specific meaning, it may be defined accordingly and should be interpreted as such. Unless otherwise defined, all terms used in this specification, including technical and scientific terms, are to be understood as having the meanings commonly understood by those skilled in the art to which the present disclosure belongs. Also, terms defined in commonly used dictionaries are not to be interpreted in an idealized or overly broad sense unless explicitly defined otherwise.

As used in this specification, the term “and/or” includes each of listed items as well as any combination of one or more of them. Also, singular expressions shall be understood to include plural forms unless otherwise indicated. The term “comprises” and/or “comprising” used in this specification does not exclude the presence or addition of one or more other components in addition to the stated components. Numerical ranges expressed using “to” include both the lower and upper limits indicated. The term “about” or “approximately” indicates a value or range within 20% of the stated number or range, unless explicitly defined otherwise.

In this specification, ordinal modifiers such as “first component,” “second component,” or “first-1 component” are used only to distinguish one component from another. For example, a component referred to as the first component in one embodiment may be referred to as the second component in another embodiment. Likewise, a component referred to as the first component in the description of the disclosure may be referred to as the second component in the claims.

The size, thickness, width, length, and the like of components shown in the drawings may be exaggerated or reduced for convenience and clarity of explanation, and embodiments of the present disclosure are not limited to the illustrated form.

Spatially relative terms such as “above,” “upper,” “on,” “below,” “beneath,” and “lower” may be used to conveniently describe the relationships between elements as illustrated in the drawings. Such spatial terms are to be understood to encompass different orientations in addition to the orientation shown in the drawings. For example, if an element shown in the drawing is turned over, an element described as “below” or “beneath” may now be positioned “above” another element. Thus, as an example, the term “below” may include both upward and downward directions.

Hereinafter, some embodiments of the present disclosure will be described in detail with reference to the accompanying drawings.

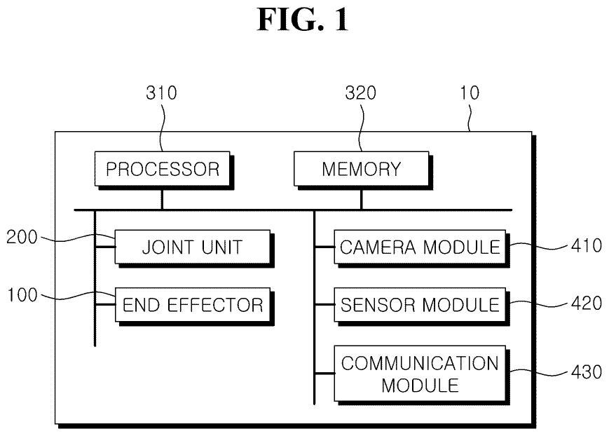

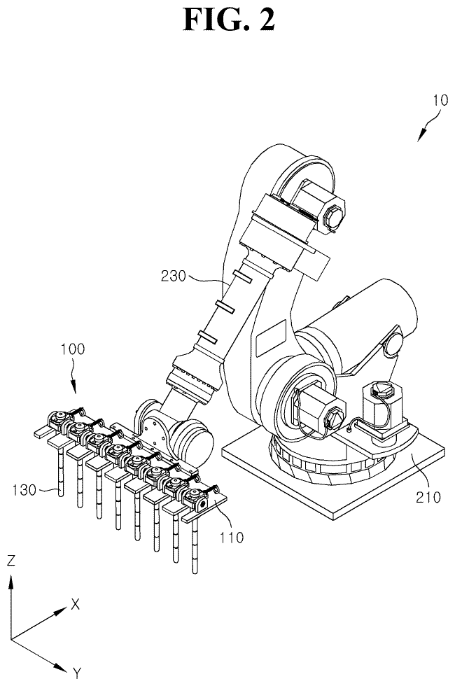

FIG. 1 illustrates a hardware configuration diagram of a robot device according to an embodiment of the present disclosure. FIG. 2 illustrates a perspective view of the robot device of FIG. 1.

Referring to FIGS. 1 and 2, a robot device 10 according to the embodiment may include a joint unit (or a joint arm) 200, an effector (e.g., end effector) 100 disposed at an end of the joint unit 200, and a processor 310, and may further include a memory 320, an image capture device (e.g., a camera module) 410, a sensor (e.g., a sensor module) 420, and a communication module (e.g., a communication circuit or chip) 430. For example, the robot device 10 may include a computing device that includes the processor 310 and the memory 320, and the robot device 10 including the processor 310 may be regarded as a subject that performs the control method described below. Specifically, the processor 310 may execute a program stored in the memory 320 so as to control movement of the end effector 100 through the joint arm 200, as will be described below in more detail.

The joint unit (or the joint arm) 200 may be provided to move the end effector 100 of the robot device 10. In some embodiments, the joint arm 200 may be a robotic arm having one or more joints to provide a given degree of freedom. For example, the joint unit 200 may have six degrees of freedom, four degrees of freedom, or three degrees of freedom. That is, through the motor of the joint unit 200, it is possible to control the coordinates of the end effector 100 in a first direction (X), a second direction (Y), and a third direction (Z), for example, the X, Y, and Z coordinates, and/or the rotational coordinates (RX, RY, RZ) with respect to the X-, Y-, and/or Z-axes. FIG. 2 illustrates an example of the joint unit 200, but its shape is not particularly limited to the embodiment of FIG. 2 as long as the joint unit can control the coordinates of the end effector 100.

Hereinafter, the first direction (X) and the second direction (Y) are described as directions lying in the horizontal plane, and the third direction (Z) is described as a direction parallel to the gravitational direction, by way of example; however, the terms used in the claims are not limited to this interpretation.

The joint unit 200 may include a joint base 210 (or a robot base) and a joint portion 230. The operation of the joint motor in the joint portion 230 may be controlled by the processor 310, which will be described later. The joint base 210 refers to a reference part or position that serves as the basis for the movement of the joint unit 200. Hereinafter, it is assumed, by way of example, that cargo (not shown), which is a target of unloading, is located on one side in the first direction (X) relative to the robot device 10 or the joint base 210. Also, as an example, when the end effector 100 retracts, it may indicate that, in terms of position along the first direction (X), the end effector 100 moves toward the joint base 210 in the first direction (X). When the end effector 100 advances, it may indicate that, in terms of position along the first direction (X), the end effector 100 moves toward the cargo in a direction opposite to the first direction (X). Alternatively, the front may refer to the one side direction of the first direction (X), and the rear may refer to the opposite side direction of the first direction (X).

Although not illustrated in the drawings, a conveyor (not shown) may be disposed between the cargo (not shown) and the joint base 210. As will be described later, individual objects (or cargo items) that are partially swept down by the operation of the end effector 100 may fall onto the conveyor and may be transported toward the opposite side in the first direction (X) by the conveyor.

The end effector 100 may be a part that directly contributes to the unloading of cargo, specifically, to sweeping the cargo from the upper front surface, by the robot device 10. The end effector 100 may include a body plate 110 and a plurality of rods 130 coupled (or connected), for example, mechanically coupled with the body plate 110. Details regarding the end effector 100 will be described below.

The processor 310 may implement operations and/or functions related to a method according to embodiments of the present disclosure, based on instructions of software that implements such a method and is stored in the memory 320. That is, the processor 310 may be understood as an entity that executes the program. For example, the processor 310 may execute software to control hardware and/or software components connected thereto and may perform data processing or computation. That is, the processor 310 may, as part of data processing or computation, store commands or data received from other components into the memory 320, process commands or data stored in the memory 320, or store result data into the memory 320. The processor 310 may use known components, and may, for example, be implemented using an Application-Specific Integrated Circuit (ASIC), or other chipsets, logic circuits, and/or data processing devices.

The memory 320 may store various data used in at least one component. Such data may include input or output data related to software and associated instructions. The memory 320 may include volatile memory and/or non-volatile memory. For example, the volatile memory may use known technology and may be implemented using ROM (Read-Only Memory), RAM (Random Access Memory), flash memory, memory cards, storage media, and/or other storage devices.

The non-volatile memory, such as storage, may store components for executing the software that implements a method according to embodiments of the present disclosure, including an application programming interface (API), libraries, and resource files. In addition, the storage may store the software implementing the method and the associated database. It will be understood that the database may contain various contents required to perform operations and/or functions related to a method according to embodiments of the present disclosure, which will be described later.

The camera module 410 may collect image information of target objects located outside or around the robot device 10, particularly including cargo (not shown). The camera module 410 may use known technology. The camera module 410 may be controlled by an image collection part (e.g., an image collection circuit) 311, which will be described later.

The sensor module 420 may measure various physical quantities related to the robot device 10, or detect the operating state of the robot device 10 and convert the measured data into electrical signals for output. The sensor module 420 may include an acceleration sensor, an angular velocity sensor, a geomagnetic sensor, a gesture sensor, a proximity sensor, an illuminance sensor, a color sensor, a magnetic sensor, a pressure sensor, and/or an optical sensor. The physical quantities measured by the above-listed sensors, and the measurement methods thereof, may utilize known techniques. Alternatively, multiple of the listed sensors may be combined and configured as a composite structure.

FIG. 1 illustrates the camera module 410 and the sensor module 420 as being included in the robot device 10 and configured separately from the joint unit 200 and the end effector 100; however, embodiments of the present disclosure are not limited thereto. For example, the camera module 410 and the sensor module 420 may be coupled to the joint unit 200 and/or the end effector 100, and understood to be included within the joint unit 200 and/or the end effector 100.

The communication module 430 may support the establishment of wired or wireless communication channels between the robot device 10 and external computing devices, such as a control terminal (not shown), a server (not shown), or other hardware components, as well as data communication over the established channels. The communication module 430 may include a wired communication module or a wireless communication module. An example of the wired communication module may be a LAN communication module. The wireless communication module may transmit and receive data via a communication network. Examples of such communication networks may include public wired networks such as Ethernet, x Digital Subscriber Line (xDSL), Hybrid Fiber Coax (HFC), and Fiber To The Home (FTTH). Other examples of communication networks may include mobile networks such as Code Division Multiple Access (CDMA), Wideband CDMA (WCDMA), High Speed Packet Access (HSPA), and Long Term Evolution (LTE). Alternatively, the wireless communication module may include short-range communication modules such as Wi-Fi, Bluetooth, or Near Field Communication (NFC).

The various components of the robot device 10 illustrated in FIG. 1 are connected via a data bus, and data may be transmitted between the components through the data bus. In addition, as described above, the robot device 10, which includes the processor 310 and implements operations and/or functions related to a method according to embodiments of the present disclosure based on instructions of software implementing such a method of the present disclosure, may be understood or described in terms of functional or logical elements.

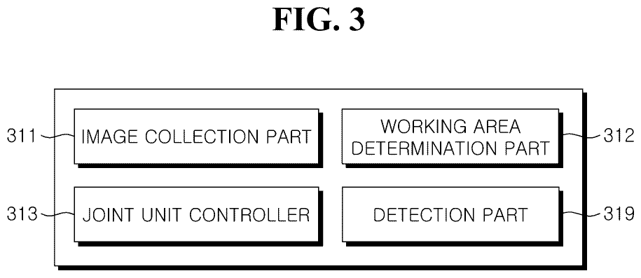

FIG. 3 illustrates a logical block diagram of the robot device shown in FIG. 1, according to an embodiment of the present disclosure.

Referring further to FIG. 3, the robot device 10 and/or the processor 310 may include an image collection part 311, a working area determination part 312, a joint unit controller 313, and a detection part 319. The roles and functions of each part will be described later in conjunction with the control method according to embodiments of the present disclosure. However, various embodiments of the present disclosure are not limited to the logical configuration of the robot device 10 in FIG. 3, and various logical configurations for implementing the above-described hardware and the methods described below are possible.

The various components shown in FIG. 3 may be implemented using various means, such as hardware, firmware, software, or a combination thereof. In other words, the “˜ part” elements in FIG. 3 may refer to hardware configurations such as a processor or a circuit, and/or software configurations executed by such hardware.

Specifically, when a component referred to as a “˜part” is implemented by hardware, it may be implemented through the above-described processor. In the case of implementation using firmware or software, it may be embodied in the form of modules, codes, code segments, procedures, functions, or the like that include instructions for performing the described functions or operations, and may be recorded on a computer-readable recording medium through various computing means. The recording medium may include program instructions, data files, and data structures either individually or in combination. In this case, each component in a configuration or block diagram may refer to a module, segment, or portion of code that includes one or more executable instructions for executing a specified logical function. Accordingly, the functions provided by components in the configuration or block diagram may be implemented by a plurality of more detailed subcomponents, or multiple components in the diagram may be integrated into a single component. That is, within the scope of the present disclosure, each component may be selectively combined and operate in one or more combinations. In addition, all components may be implemented as respective independent hardware units, or some or all of them may be selectively combined and implemented as a computer program including program modules that perform some or all of the combined functions on one or more hardware systems. The codes and code segments that constitute such a computer program can be derived by those skilled in the art to which the present disclosure pertains in light of teachings of the present disclosure.

The program instructions recorded on the recording medium described in this specification may be specially designed and configured for embodiments of the present disclosure, or may be publicly known and available for use by those skilled in computer software. For example, the recording medium may include magnetic media such as hard disks, floppy disks, and magnetic tapes; optical media such as CD-ROMs and Digital Video Disks (DVDs); magneto-optical media such as floptical disks; and hardware devices such as ROM, RAM, and flash memory that are specially configured to store and execute program instructions. Examples of program instructions may include machine language code generated by a compiler as well as high-level language code executable by a computer using an interpreter or the like. Such hardware devices may be configured to operate as one or more software programs to perform the operations of embodiments of the present disclosure, and the reverse is also true.

Hereinafter, the end effector 100 of the robot device 10 according to embodiments will be described in further detail.

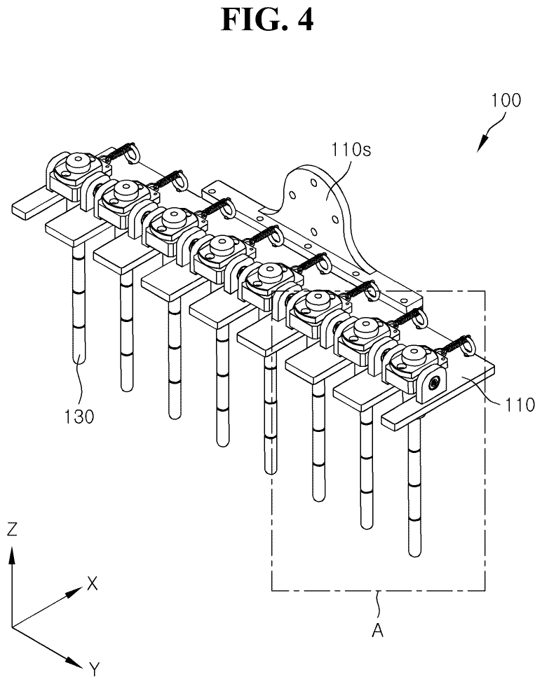

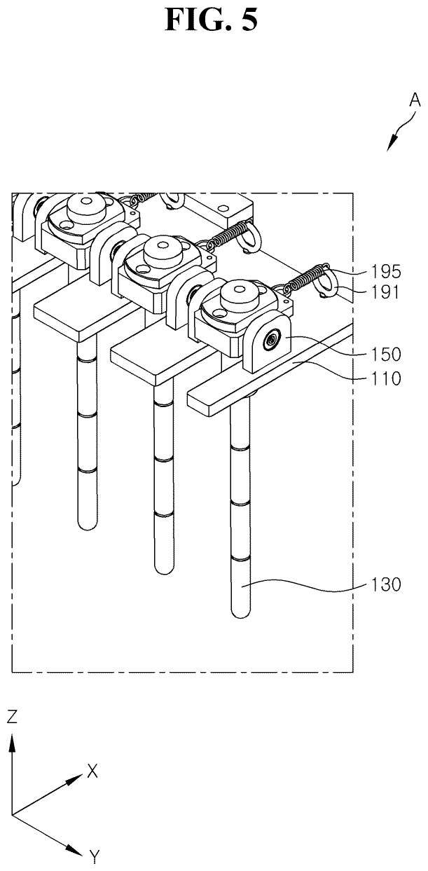

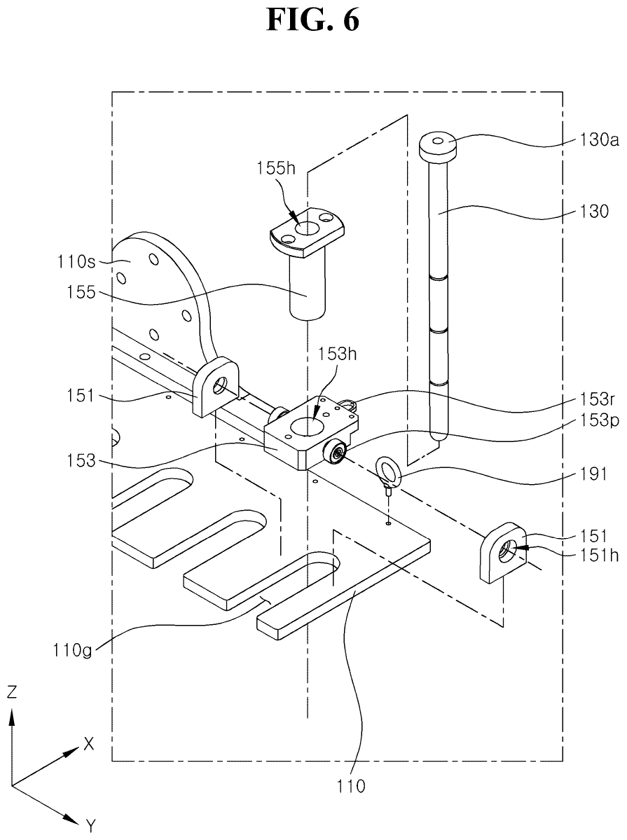

FIG. 4 is a perspective view illustrating the end effector of the robot device in FIG. 2. FIG. 5 illustrates the enlarged view of area A in FIG. 4. FIG. 6 is an exploded perspective view of the end effector in FIG. 5. In particular, FIG. 6 illustrates an exploded perspective view of a single unit structure.

Referring further to FIGS. 4 to 6, the end effector 100 of the robot device 10 includes the body plate 110 and the rods 130 mechanically coupled to the body plate 110, and may further include a hinge unit 150.

The body plate 110 (also referred to as a frame) may be a plate-shaped member that forms the body of the end effector 100. Although the shape of the body plate 110 is not particularly limited, the body plate 110 may extend in a longitudinal direction thereof (e.g., the second direction (Y) in FIG. 4) so that the plural rods 130 can be arranged in that direction, as will be described later. The material of the body plate 110 is also not particularly limited, but it may be made of a material with relatively high strength and rigidity, such as metal.

The body plate 100 in FIG. 4 may include one or more grooves 110g (e.g., plate grooves) each extending in a transverse direction (e.g., the first direction X in FIG. 4) in the plane of the body plate 100 of the body plate 100. That is, each of the grooves 110g may extend from a first edge of the body plate 110 in the first direction (X).

The plate grooves 110g may be repeatedly arranged in the second direction (Y), similar to the rods 130. Any one of the plural plate grooves 110g may contribute to the formation of a single unit structure together with a corresponding one of the rods 130, as will be described later. The plate grooves 110g may provide a space that allows the rods 130 placed therein to move in a direction parallel to the first direction (X) or rotate about the Y-axis extending in the second direction (Y). The end effector 100 may operate in a state where the plate grooves 110g are generally arranged to face the direction of the cargo (not shown). That is, in the following explanation, where the first direction (X) is defined from one side to the other side in FIG. 4, the one side in the first direction (X) (the lower-left side in FIG. 4) is referred to as the cargo side, i.e., the front side, and the other side in the first direction (X) (the upper-right side in FIG. 4) is referred to as the joint base 210 side, i.e., the rear side. However, embodiments of the present disclosure are not limited thereto, and the end effector 100 may be coupled to the end of the joint unit 200, such that its coordinates, rotation direction, and the like may vary according to embodiments.

At a second edge of the body plate 110 opposite the first edge of the body plate 110 in the first direction (X), a joint-coupling part 110s may be provided. The joint-coupling part 110s may provide a planar region defined approximately by the second direction (Y) and the third direction (Z), and may be configured such that a fastening member such as a bolt penetrates through it to be coupled with an end portion (e.g., the end) of the joint unit 200. For example, the joint-coupling part 110s may include a plurality of holes through which corresponding fastening members pass to couple the joint-coupling part 110s to an end portion of the joint unit 200.

The rods 130 (also referred to as pins or bars) may be mechanically coupled to the body plate 110. That is, when the coordinates, orientation, or rotation of the body plate 110 change due to the joint unit 200, the rods 130 may move together with the body plate 110, resulting in a change in their position. The coupling between the rods 130 and the body plate 110 will be described in detail below.

A hinge unit (or a hinge assembly) 150 may be disposed on the body plate 110. The hinge unit 150 may include a hinge bracket 151 (or a hinge base) and a hinge block 153. The hinge unit 150 may be configured such that a corresponding (e.g., coupled) one of the rods 130 is tilted with respect to the body plate 110 in a plane perpendicular to or intersecting the arrangement direction of the plural rods 130, for example, in a plane that is defined by the first direction (X) and the third direction (Z) and perpendicular to the second direction (Y).

The hinge bracket 151 may be fixedly disposed on the upper surface of the body plate 110. The hinge bracket 151 may be provided as a pair, spaced apart from each other across a plate groove 110g in a planar view, although embodiments of the present disclosure are not limited thereto.

The hinge block 153 may be inserted between a pair of hinge brackets 151 that are spaced apart in the second direction (Y). With the hinge brackets 151 fixed on the body plate 110, the hinge block 153 may be configured to rotate relative to the hinge brackets 151 in a plane defined by the first direction (X) and the third direction (Z). In other words, the hinge block 153 may be configured to rotate relative to the hinge brackets 151 about the Y-axis extending in the second direction (Y). For example, the hinge block 153 may include a hinge pin portion 153p, which may be inserted into a hinge hole 151h of the hinge bracket 151. However, embodiments of the present disclosure are not limited thereto and a rotation axis may alternatively be formed using a shaft or the like.

The hinge block 153 may have a rod hole 153h. The rod hole 153h may pass through the hinge block 153 in the third direction (Z). The rods 130 may be at least partially inserted into the rod hole 153h. Each rod 130 may include a rod head 130a provided at its upper end in the third direction (Z), and while the lower portion of the rod 130 is inserted into the rod hole 153h, the rod head 130a may be configured not to be inserted into the rod hole 153h. Specifically, a size of the bushing hole 155h may be sufficiently small to prevent the rod head 130a passing therethrough, thereby stopping the rod head 130a above the rod hole 153h. That is, the rod head 130a may function as a stopper that defines the insertion limit of the rods 130.

In some embodiments, the hinge unit 150 may further include a bushing member 155 coupled to the hinge block 153. The bushing member 155 may be implemented as a linear bushing or the like, although embodiments of the present disclosure are not limited thereto. As will be described later, the rods 130 may be capable of vertical movement in both upward and downward directions along the third direction (Z) while being inserted into the hinge block 153. To facilitate such vertical movement of the rods 130, the hinge unit 150 may further include the bushing member 155. Specifically, the bushing member 155 may be at least partially inserted into the rod hole 153h of the hinge block 153, and the rods 130 may be inserted into a bushing hole 155h of the bushing member 155.

Through this structure, the body plate 110 and the rods 130 are coupled together, and the hinge block 153 and the rods 130 may be tilted with respect to the hinge bracket 151 and the body plate 110. The operational effects of this configuration will be described in detail later.

In this specification, even if the rods 130 do not form a direct mechanical coupling with the body plate 110, the rods 130 and the body plate 110 may still be understood to be mechanically coupled when mechanical elements are interposed, such as when the body plate 110 is coupled with the hinge unit 150, and the hinge unit 150 is coupled with the rods 130.

In an embodiment, in a certain state, the rods 130 may be at least partially positioned within the plate grooves 110g of the body plate 110. Accordingly, in such a state or at any time, the rods 130 may overlap with the body plate 110 in a horizontal direction that includes the first direction (X) and the second direction (Y).

Accordingly, from a side view and in a certain state, the rods 130 may be at least partially located below the lower surface (or one surface, or first surface) of the body plate 110, and at least partially located above the upper surface (or other surface, or second surface) of the body plate 110.

In other words, the rods 130 may be partially protruded below the lower surface of the body plate 110 and simultaneously protruded above the upper surface of the body plate 110. In this case, the rods 130 may be configured such that the protrusion length from a surface of the body plate 110, for example, below the lower surface of the body plate 110, is variable. In some embodiments, the rods 130 may be each directly or indirectly freely coupled to the body plate 110 so as to make the rods 130 be tilted with respect to the body plate 110 by gravity or an external force. For example, the rods 130 may be freely coupled with the body plate 110 and/or other structures fixed on the body plate 110 (e.g., the hinge unit 150).

In this specification, “one component is freely coupled to another component” indicates that two components are coupled such that they do not separate due to mechanical constraint and move together, while still allowing relative positional changes between them due to gravity and/or other external forces without the need for any additional or external power source.

For example, as shown in FIG. 4, when the third direction (Z) is parallel to the direction of gravity, the rods 130 may sag downward due to gravity. As described above, the downward movement of the rods 130 may be limited by the rod head 130a.

In addition, if a force opposite to gravity is applied to the lower end of the rods 130, the rods 130 may be pushed upward while maintaining their mechanical coupling with the body plate 110, thereby moving vertically. In this case, the protrusion length of the rods 130 below the lower surface of the body plate 110 may decrease.

Furthermore, when the force applied to the lower end of the rods 130 is removed, the rods 130 may again sag downward due to gravity and may vertically translate in a linear motion. In this case, it may be understood that the protrusion length of the rods 130 below the lower surface of the body plate 110 increases.

In another example, in a certain state as illustrated in FIG. 4, the rods 130 may extend in the direction of gravity and may sag downward due to gravitational force.

In addition, when a horizontal force is applied to any position of the rod 130, for example, toward one side in the first direction (X), the rod 130 inserted into the hinge block 153 may tilt together with the hinge block 153 within a plane defined by the first direction (X) and the third direction (Z). As previously described, the tilting axis in this case is formed by the hinge block 153 and the hinge bracket 151.

Furthermore, when the force that causes the rods 130 to tilt is removed, the rods 130 may return to their original state and extend in a direction opposite to the third direction (Z) (e.g., the direction of gravity). This restoration may be accomplished by the center of gravity of the rods 130 and gravity itself, but a separate non-powered mechanism may also be provided to release the tilt and assist in returning the rods 130 to their original state.

In an embodiment, to enable the restoration, the end effector 100 may further include an elastic member 195 and a fixing structure 191 for securing the elastic member 195. The elastic member 195 may be in a contracted state initially, and its length increases under the application of an external force, and may return to the initial or a nearly contracted state once the external force is removed. An example of the elastic member 195 may include a spring, etc.

One end of the elastic member 195 may be coupled with a fixed end 153r of the hinge block 153. The other end of the elastic member 195 may be fixed on the body plate 110. Specifically, the fixing structure 191 may be fixedly arranged on the body plate 110, and the other end of the elastic member 195 may be coupled and secured to the fixing structure 191. For example, the fixing structure 191 may include an eye bolt.

In some embodiments, a load cell (not shown) may be provided at one end of the elastic member 195, for example, at the other end. For instance, the fixing structure 191 may include a load cell. The load cell may be used to measure the tensile force or load applied to the elastic member 195. The load cell may be controlled by the detection part 319 or may provide input values to the detection part 319. The load cell may be understood as one component of the sensor module 420.

In the initial state of the elastic member 195, i.e., in its maximum contracted state, the extension direction of the rods 130 may be approximately perpendicular to a surface (e.g., the upper surface or the lower surface) of the body plate 110. For example, the extension direction of each of the rods 130 may form an angle with respect to a direction parallel to the surface of the body plate 110 from 85 degrees to 95 degrees, from 87 degrees to 93 degrees, or from 89 degrees to 91 degrees. Alternatively, the extension direction of each of the rods 130 may form an angle with respect to the surface of the body plate 110 in +10% (i.e., from 81 degrees 99 degrees). If a horizontal force is applied to any portion of the rod 130, the hinge block 153 may rotate and the rod 130 may tilt despite the restoring force of the elastic member 195, and the elastic member 195, which is coupled to the hinge block 153, may become elongated. Therefore, when the external force causing the tilt of the rod 130 is removed, the hinge block 153 may be urged to return to its original position by the restoring force of the elastic member 195, thereby restoring the extension direction of the rod 130.

This embodiment illustrates a case in which the elastic member 195 is used as a means for restoring the tilt of each of the rods 130. However, embodiments of the present disclosure are not limited thereto, and various other restoring structures may be adopted by those skilled in the art.

Meanwhile, a reference load for tilting the rods 130 may be set by utilizing the elasticity of the elastic member 195. For example, when a force of about 1 kgf is applied to one of the rods 130, the external force may not be sufficient to stretch the elastic member 195, so the rods 130 may not be tilted. In contrast, when a force of about 5 kgf is applied to one of the rods 130, the external force may rotate the hinge block 153 despite the restoring force of the elastic member 195. In other words, the rods 130 of the end effector 100 of the robot device 10 according to the embodiment may be configured to tilt when a load equal to or greater than the reference load is applied, and not to tilt when a load less than or equal to the reference load is applied.

As described in detail above, the body plate 110 and the rods 130 may form a mechanical coupling with each other so that they may operate together without being disassembled. However, when a force is applied to the rods 130 in the third direction (Z) and/or in a horizontal direction, specifically in a direction parallel to the first direction (X), the rods 130 may vertically move in the up-down direction or tilt with respect to the body plate 110.

As a non-limiting example, the end effector 100 may not be provided with a separate power source or power transmission system for the movement of the rods 130 themselves, or a controller for such purposes. For example, components such as a shifter or rollers for the vertical movement of the rods 130 may be omitted. In another example, a mechanical structure for enabling the elongation or contraction of the length of the rods 130 themselves may be omitted. In yet another example, components such as gears near the hinge unit 150 for rotating the rods 130 may be omitted. For example, the rods 130 may vertically move or tilt only by gravity or external force applied thereto, and may not be configured to vertically move or tilt in response to an electrical signal from the processor 310.

In addition, the rods 130 may be configured such that their protrusion lengths beyond the lower and upper surfaces of the body plate 110 vary, but the lengths of the rods 130 themselves may not be configured to expand or contract. That is, when the rods 130 move vertically downward, the protrusion length below the lower surface of the body plate 110 may increase, and the protrusion length above the upper surface of the body plate 110 may decrease by the same amount. The same may be understood in the case where the rods 130 move vertically upward. In other words, the length of each of the rods 130 in the longitudinal direction may be substantially maintained.

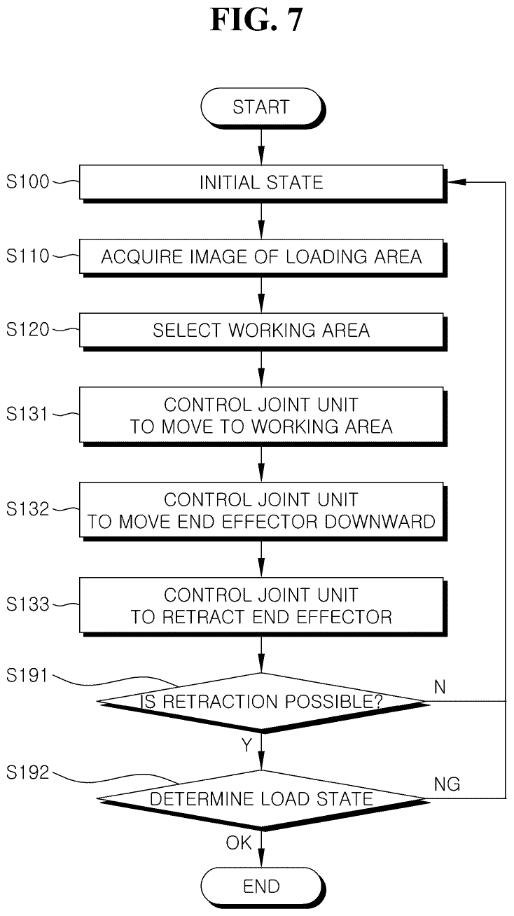

Hereinafter, a method of controlling the robot device according to an embodiment will be described in more detail with reference to FIG. 7. FIG. 7 is a flowchart illustrating a control method of a robot device according to an embodiment of the present disclosure.

Referring further to FIG. 7, the control method of the robot device according to the present disclosure may be a method performed by the robot device 10 including the processor 310 or at least one processor 310, and may include a step (S100) of controlling an initial posture, a step (S110) of acquiring an image of a loading area, a step (S120) of analyzing the acquired image or video to select a working area, and steps (S131, S132, S133) of moving the end effector 100, and may further include a step (S191) of determining whether retraction is possible and a step (S192) of determining a load state.

First, the step (S100) of controlling an initial posture may refer to a step of setting the coordinates and rotation directions (RX, RY, RZ) of the joint unit 200 and of the end effector 100 due to the joint unit 200 to initial states.

In addition, the image collection part 311 may acquire image information using the camera module 410 or the like (S110). Specifically, it may collect image information that enables identification of the arrangement or layout of cargo, which is an object to be unloaded, or the arrangement between cargo and surrounding structures.

Next, the working area determination part 312 may derive a region, position, or coordinates for performing a task using the end effector, based on the acquired image information (S120).

Specifically, from the collected image information, an image of the cargo items from a top view may be derived, and boundary lines of individual cargo items (objects) may be extracted from the top-view image. In addition, gaps between the extracted boundaries of the objects may be recognized.

If multiple gaps are recognized, one of the gaps located within a predefined working range, taking into account the operating range of the joint unit 200, for example, within a reachable distance in the first direction (X), may be defined as the working area. More specifically, if multiple gaps exist within the working range, the gap located furthest forward in the first direction (X) among the multiple gaps may be defined as the working area.

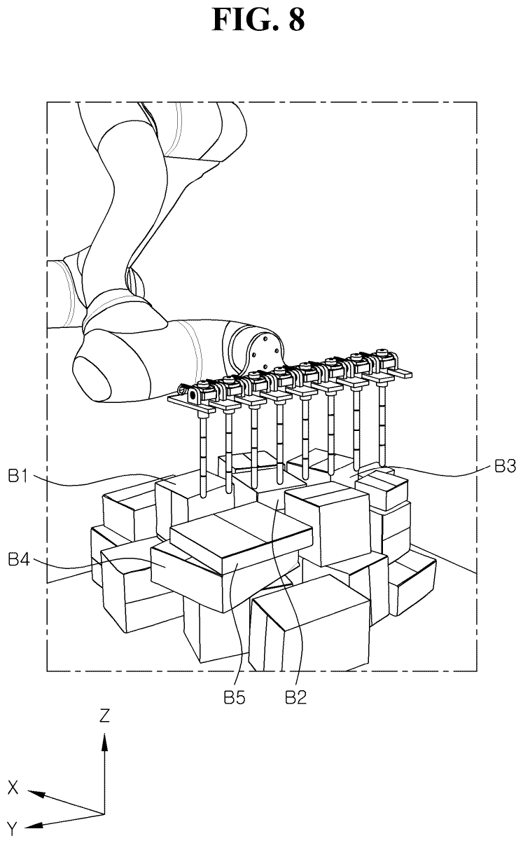

Next, the joint unit controller 313 may control the joint motor of the joint unit 200 to move the end effector 100 forward to one side in the first direction (X), retract it to the other side in the first direction (X), move it in the second direction (Y) (i.e., the width direction or transverse direction), or move it up and down in the direction of gravity (i.e., the third direction (Z)) (S131). Also, the end effector 100 may be rotated within a three-dimensional coordinate space. For related reference, see FIG. 8. In some embodiments, at S131, a processor (e.g., the processor 310 in FIG. 1) may control the joint arm 230 to perform a first movement to move the end effector 100 above a cargo elevation (e.g., above an upper surface of the cargo). For example, at S131, a method of operating the robot device according to an embodiment of the present disclosure includes moving at least one rod of the end effector 100 above loaded (e.g., stacked) cargo items.

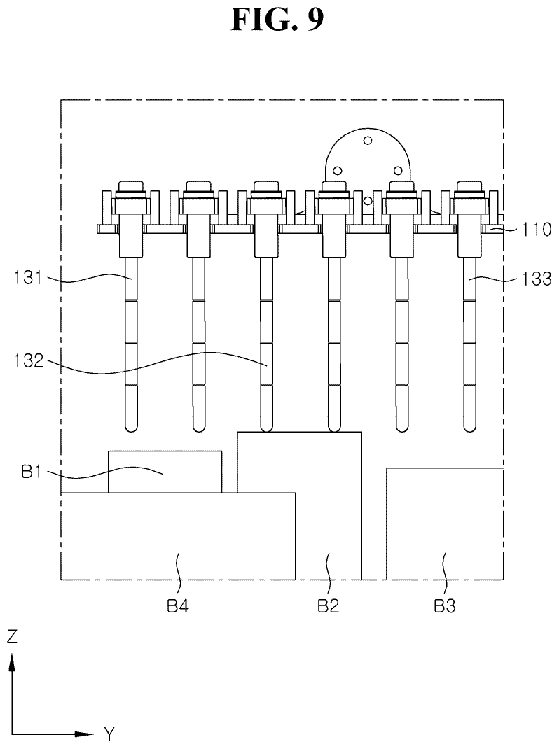

FIG. 8 is a schematic diagram illustrating step (S131), in which the joint unit controller 313 controls the joint unit 200 to move the end effector 100 near the working area. FIG. 9 is a schematic diagram viewed from the first direction (X) in the state of FIG. 8. FIGS. 8 and 9 illustrates a moment when the end effector 100 is partially lowered, and a second rod 132, which is one of the plural rods 130, has its lower end contacting the top surface of a second object B2, which is the object located at the highest level among the plural cargo items B1, B2, B3, B4 and B5.

That is, the step S131 may partially include the end effector 100 descending downward in the third direction (Z), and the descent in step S131 may be distinguished from the descent in a descending step (S132) to be described below.

Referring further to FIGS. 8 and 9, in step S131, the end effector 100 may move to at least one side in the first direction (X) and be positioned above the cargo items B1, B2, B3, B4 and B5. For example, the end effector 100 may move forward in the first direction (X), or the end effector 100 may move backward in a direction opposite to the first direction (X). For example, the end effector 100 may be moved to overlap with the cargo items B1, B2, B3, B4 and B5 in the third direction (Z) (i.e., the direction of gravity) (S131).

Although not illustrated in the drawings, in step S131, the end effector 100 may be moved at least partially in the second direction (Y), i.e., the width direction, to correspond to the previously defined working area. In addition, in step S131, the end effector 100 may also be moved up and down at least partially in the third direction (Z), i.e., the height direction or the direction of gravity; however, embodiments of the present disclosure are not limited thereto.

In other words, step S131, which involves moving the end effector 100 near a working area, may include a step of positioning the end effector 100 above the defined working area and may include a process of moving to at least one side in the first direction (X).

In addition, although it may vary depending on the position of the end effector 100 in an initial posture step (S100), the end effector 100 may move in the second direction (Y) to match the Y-coordinate of the working area. Also, if the position of the end effector 100 in the initial posture step (S100) is relatively low, the end effector 100 may partially ascend in the third direction (Z), and if the initial position is relatively high, it may partially descend in the third direction (Z). Alternatively, it may perform both ascent and descent at least once to position the end effector 100 above the working area. In addition, depending on the position of the joint base 210, the end effector 100 may perform roll rotation, pitch rotation, and/or yaw rotation.

FIGS. 8 and 9 illustrate a state in which no external force is applied to a plurality of rods 131, 132, and 133, and all are sagging downward due to gravity. In addition, it illustrates a case where, among the cargo items B1, B2, B3, B4, and B5, specifically the first object B1, the second object B2, and the third object B3, which form an upper front surface of cargo, the upper end of the second object B2 is positioned at the highest elevation.

Next, the joint unit controller 313 may control the joint motor of the joint unit 200 to lower the end effector 100 in the third direction (Z), i.e., downward in the direction of gravity (S132).

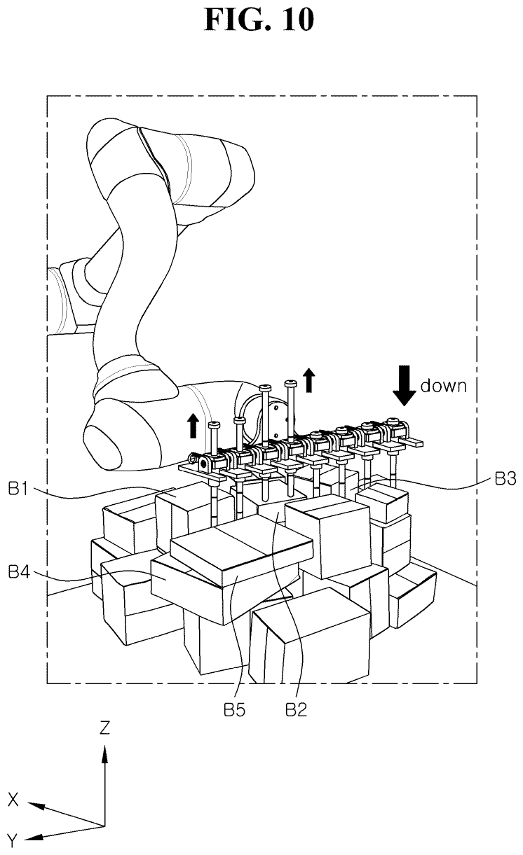

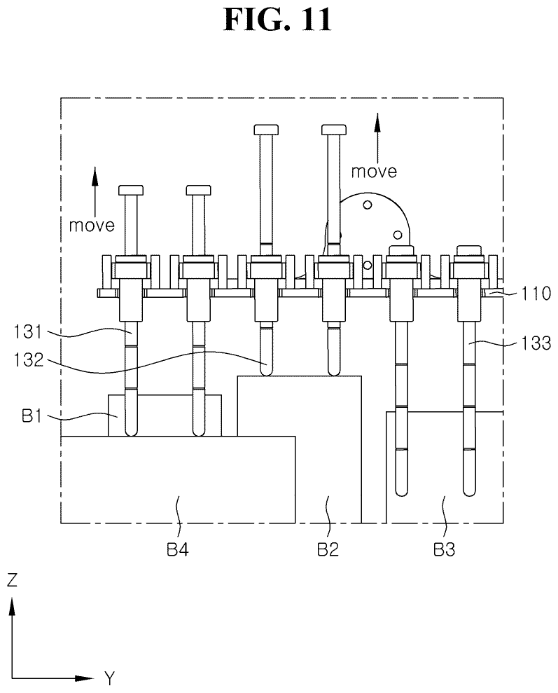

FIG. 10 is a schematic diagram illustrating step (S132), in which the joint unit controller 313 controls the joint unit 200 to lower the end effector 100. FIG. 11 is a schematic diagram viewed from the first direction (X) in the state shown in FIG. 10.

Referring further to FIGS. 10 and 11, in the step (S132), the rods 130 may be descended so as to overlap, in the horizontal direction, with at least some of the cargo items B1, B2, B3, B4, and B5 (S132). In some embodiments, at S132, a processor (e.g., the processor 310 in FIG. 1) may control the joint arm 230 to perform a second movement so as to move the end effector 100 downward. For example, at S132, a method of operating the robot device according to an embodiment of the present disclosure includes moving the end effector 100 downward.

FIG. 10 illustrates an example in which, as a result of the descent of the end effector 100, some of the rods are inserted between the boundaries of individual objects. For example, as a result of the moving of the end effector downward, one or more of the rods may be inserted between boundaries of adjacent cargo items. Specifically, in the embodiment of FIG. 10, the first rod 131 is inserted into a gap between the first object B1 and the fifth object B5, and the third rod 133 is inserted into a gap between the third object B3 and an adjacent object in the first direction (X). However, embodiments of the present disclosure are not limited thereto. For example, as a result of the descending movement step (S132), none of the rods 130 may be inserted into a gap, and the lower ends of all the rods 130 may instead come into contact with the top surfaces of the objects.

In an embodiment, one or more of the plural rods 131, 132, and 133, for example, the first rod 131, may descend in the third direction (Z) and be positioned so as to overlap with the first object B1 in the first direction (X).

Here, when the fourth object B4, which overlaps with and is adjacent to the first object B1 in the first direction (X), is present, and the first rod 131 overlaps with the fourth object B4 in the third direction (Z), the lower end of the first rod 131 may come into contact with the top surface of the fourth object B4 at some point during the descent of the end effector 100. If the end effector 100 continues to descend, the first rod 131 may be supported by the fourth object B4 and thus may no longer descend, and as a result, the first rod 131 may be pushed upward relative to the end effector 100. In other words, the protrusion length of the first rod 131 below the body plate 110 (e.g., the lower surface of the body plate 110) may be reduced.

In this state, the first rod 131 may be positioned to overlap with the first object B1 in the first direction (X) and with the fourth object B4 in the third direction (Z). Specifically, the lower end of the first rod 131 may be in contact with the top surface of the fourth object B4. In addition, with the first rod 131 positioned between the first object B1 and the firth object B5, the first object B1 and the fifth object B5 may be spaced apart from each other in the first direction (X).

In addition, one or more of the plural rods 131, 132, and 133, for example, the second rod 132, may descend in the third direction (Z). If the second rod 132 overlaps with the second object B2 in the third direction (Z), the lower end of the second rod 132 may come into contact with the top surface of the second object B2 at some point during the descent of the end effector 100. If the end effector 100 continues to descend, the second rod 132 may be supported by the second object B2 and thus may no longer descend. As a result, the second rod 132 may be pushed upward relative to the end effector 100. In other words, the protrusion length of the second rod 132 below the body plate 110 may be reduced.

As described above, in the elevation profile of the cargo items B1, B2, B3, B4, and B5, specifically in the elevation view at a certain position along the first direction (X), the second object B2 may form the highest height level. Accordingly, the second rod 132 may be pushed upward to a greater extent than the first rod 131, and the protrusion length of the second rod 132 below the lower surface of the body plate 110 may become the shortest among the first, second, and third rods 131, 132, and 133.

In this state, the second rod 132 may be positioned to overlap with the second object B2 in the third direction (Z). Specifically, the lower end of the second rod 132 may be in contact with the top surface of the second object B2. In addition, there may be no overlapping of cargo items with the second rod 132 in the horizontal direction.

In addition, one or more of the plural rods 131, 132, and 133, for example, the third rod 133, may descend in the third direction (Z) and be positioned so as to overlap with the third object B3 in the first direction (X).

Here, there may be no object located adjacent to the third object B3 in the first direction (X), and accordingly, there may be no object that interferes with and comes into contact with the lower end of the third rod 133 during the descent of the end effector 100. That is, there is no configuration for supporting the third rod 133 by contacting its lower end and linearly moving the third rod 133 upward, and even if the end effector 100 descends to a predetermined height, the third rod 133 may not be pushed upward. In other words, the protruding length of the third rod 133 below the lower surface of the body plate 110 may remain substantially the same as the initial state without being reduced.

In this state, the third rod 133 may be positioned so as to overlap with the third object B3 in the first direction (X).

To explain operational effects of the end effector 100 according to embodiments of the present disclosure, FIG. 10 and the like illustrate a case in which the cargo items B1, B2, B3, B4, and B5 are arranged in a specific state as an example.

That is, when the end effector 100 including the rods 130 that are freely coupled descends as described above, the first rod 131 may be partially pushed upward due to interference with the cargo item B4, and may form an overlapping state with the first object B1 in the first direction (X), while the second rod 132 may be partially or completely pushed upward, but there may be no object overlapping in the first direction (X). In addition, the third rod 133 may not be pushed upward and may form an overlapping state with the third object B3 in the first direction (X).

Next, the joint unit controller 313 may control the joint motor of the joint unit 200 to retract the end effector 100 toward the opposite side of the first direction (X) (S133). In some embodiments, at S133, a processor (e.g., the processor 310 in FIG. 1) may control the joint arm 230 to perform a third movement so as to retract the end effector 100. For example, at S134, a method of operating the robot device according to an embodiment of the present disclosure includes retracting the end effector 100.

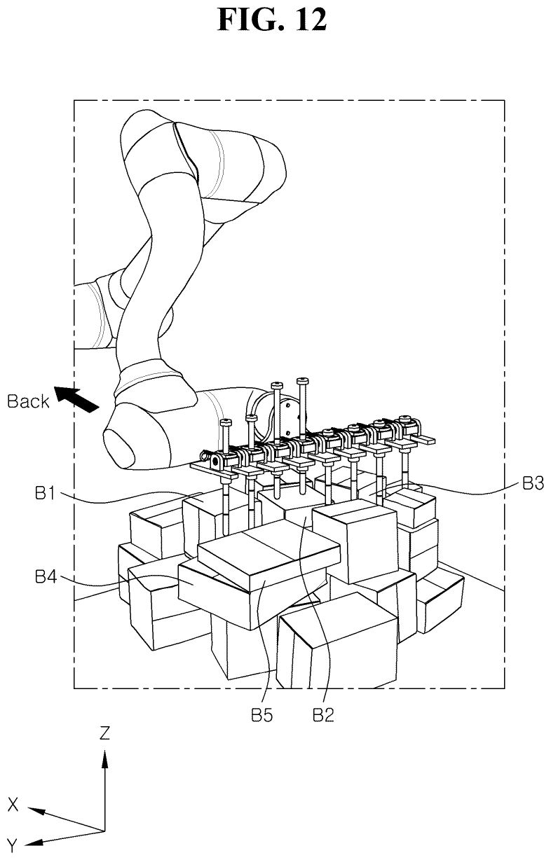

FIGS. 12 to 14 are schematic diagrams sequentially illustrating steps (S133) in which the end effector 100 is retracted.

During the retraction movement step (S133), the third direction (Z) position (or coordinate in the third direction Z) of the body plate 110 during the retraction of the end effector 100 may be substantially the same as the third direction (Z) position when the aforementioned descending movement step (S132) is completed. In some embodiments, a processor (e.g., the processor 310 in FIG. 1) may maintain a position of the body plate 110 in the third direction Z during the third movement substantially the same as that of the body plate 110 in the third direction Z at the end of the second movement. For example, a difference between the vertical position of the body plate 110 during the third movement and that of the body plate 110 at the end of the second movement may be not greater than 5%, 3%, or 1% of the vertical position (e.g., a vertical position measured from a flat surface on which the cargo items are stacked) of the body plate 110 at the end of the second movement. That is, the end effector 100 and the body plate 110 may retract in the first direction (X) while maintaining their third direction (Z) coordinate. During this process, the third direction (Z) positions of some of the rods 130 may change depending on the height of the upper front surface of the cargo. In some embodiments, as a result of the retracting of the end effector 100 in the first direction (X), one or more of the rods 130 may be inserted between boundaries of adjacent cargo items.

Referring further to FIGS. 12 to 14, when the end effector 100 retracts toward the opposite side of the first direction (X) in a state where objects (i.e., the first object B1 and the third object B3) are positioned to overlap with the rods 130 in the first direction (X) after the end effector descends, the first object B1 and the third object B3, which interfere with the rods 130, may be swept toward the opposite side of the first direction (X). In contrast, since the second rod 132 does not have an overlapping or interfering object in the first direction (X), it may not contribute to sweeping, i.e., to the unloading of the cargo.

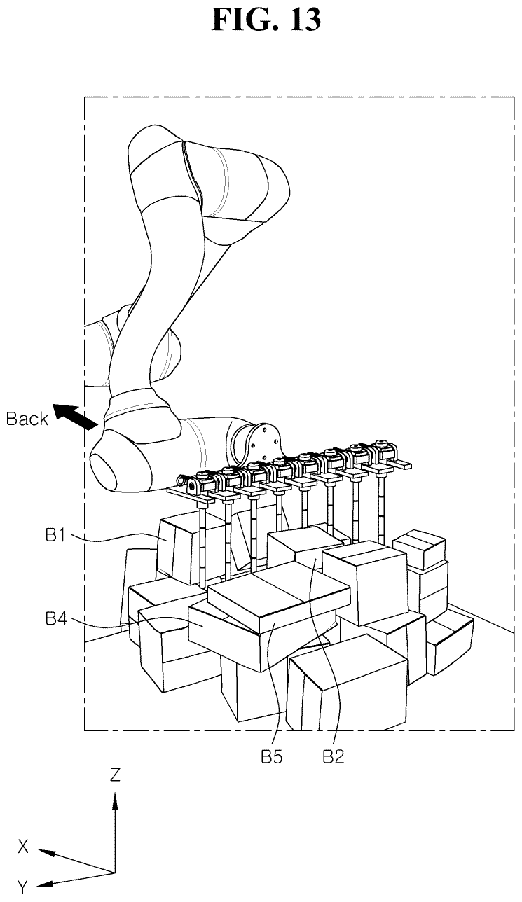

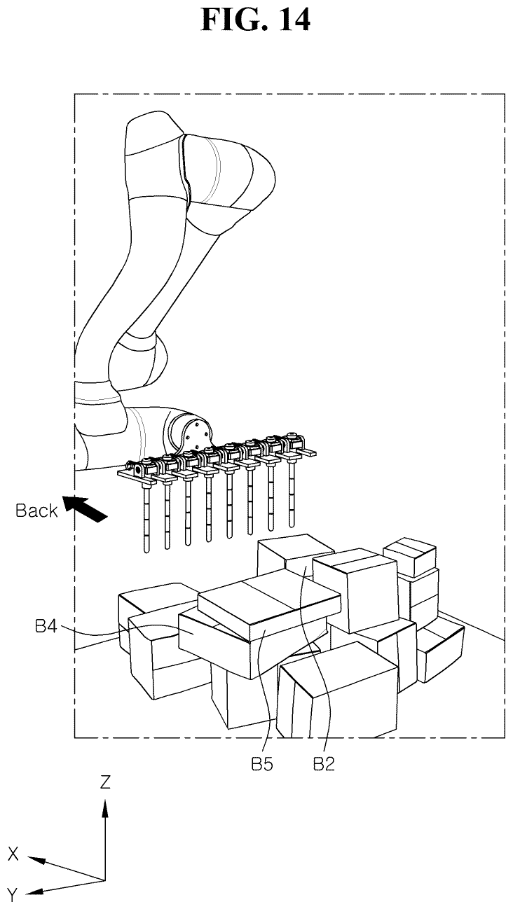

In this regard, FIG. 12 illustrates a state in which the end effector 100 retracts, and the lower end of the second rod 132 is in contact with the upper surface of a corresponding cargo item (e.g., the second object B2) and retracts along the upper surface of the second object B2, while the first rod 131 and the third rod 133 push at least the first object B1 and the third object B3, respectively, rearward (e.g., in the first direction X). FIG. 13 illustrates a state in which the end effector 100 retracts further, causing the second rod 132 to move so as to no longer overlap with the second object B2 in the third direction (Z), thereby removing the supporting force on the second rod 132 and allowing it to sag downward in the direction of gravity. FIG. 14 illustrates a state in which the end effector 100 retracts even further, and the first object B1 and the third object B3 are pushed off by the first rod 131 and the third rod 133, respectively.

In the embodiment of FIGS. 10 to 14 described above, a case is illustrated in which some of the rods 130 are inserted into gaps as a result of the descending movement step (S132). However, in another embodiment, as a result of the descending movement step (S132), none of the rods 130 are inserted into the gaps, and during the retraction movement step (S133), at least some of the rods may be inserted into the gaps between objects spaced apart in the first direction (X) during the retraction process in the first direction (X), and as a result, a certain rod and an object may overlap in the first direction (X) and sweep the interfering object.

As described above with reference to FIGS. 8 to 14, the end effector 100 includes a plurality of rods 130, and may sweep cargo objects that interfere with corresponding ones of the rods 130 in the first direction (X) toward the opposite side of the first direction (X).

In particular, each of the plural rods 130 is configured to be independently pushed upward in the third direction (Z) so that its protruding length is variable, allowing some of the rods (i.e., the first rod 131 and the third rod 133) to be inserted into gaps between individual objects (e.g., cargo items) located at an upper end portion of the entire cargo items (or the cargo), and allowing other rods (i.e., the second rod 132) to be pushed upward when no such gaps exist.

Unlike embodiments of the present disclosure, if the protruding lengths of the rods are not adjustable (in other words, if all of the plural rods have the same protruding length below the lower surface of the body plate, when the cargo items are not substantially aligned to form gaps extending in the second direction (Y) and the gaps are not uniform), the rods may not be inserted into the gaps between objects due to interference between the rods and the objects.

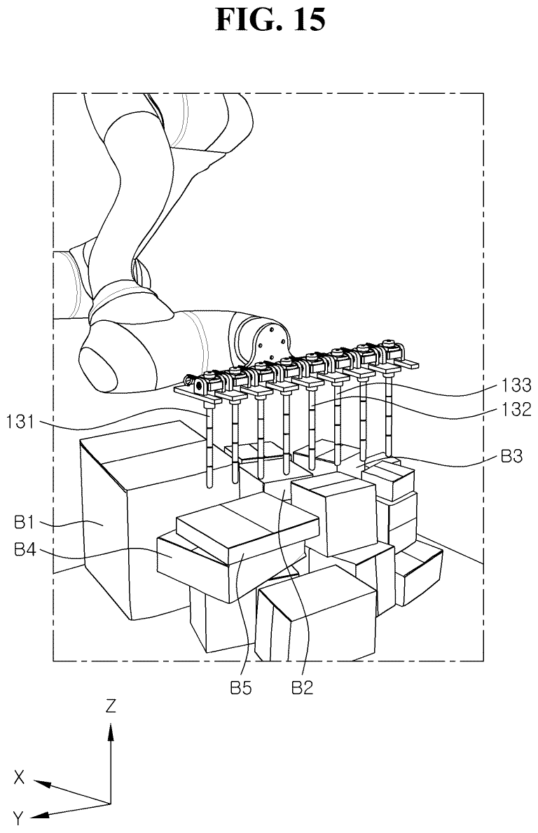

Meanwhile, the operational effects resulting from the configuration in which the rods 130 are allowed to tilt will be described. In this regard, FIG. 15 and the like are further referenced.

FIG. 15, similar to FIG. 8, is a schematic diagram illustrating the step (S131) in which the joint unit controller 313 controls the joint unit 200 to move the end effector 100 to the vicinity of the work area. That is, FIG. 15 illustrates the moment when the end effector 100 has partially descended and the lower end of one of the plural rods 130 touches the upper surface of an object located at the highest position among the plurality of cargo items B1, B2, B3, B4, and B5.

FIG. 15 illustrates a state in which no external force is applied to the plural rods 131, 132, and 133, and all are sagging downward due to gravity. Since the step S131 has already been described in detail with reference to FIG. 8 and the like, repeated explanation may be omitted for the interest of brevity.

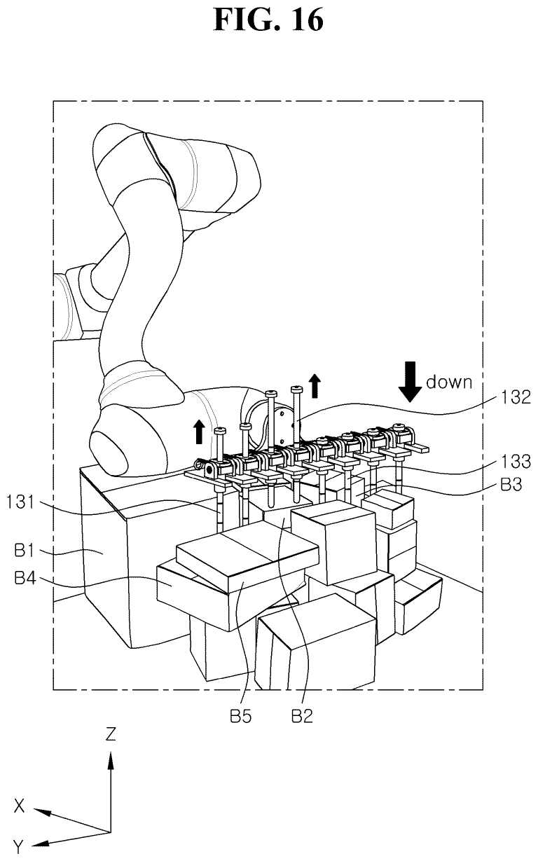

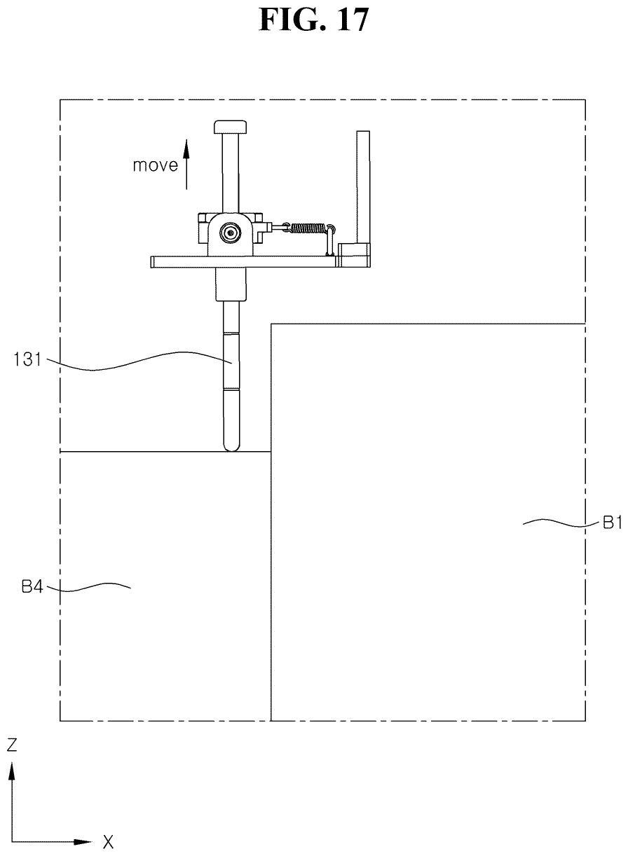

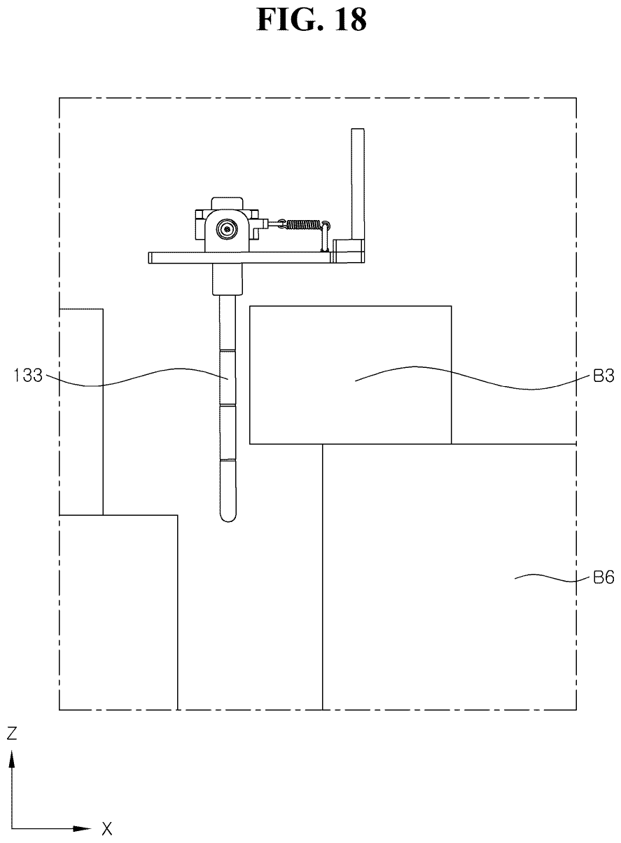

FIG. 16, similar to FIG. 10, is a schematic diagram illustrating the step (S132) in which the joint unit controller 313 controls the joint unit 200 to lower the end effector 100. FIG. 17 is a schematic diagram showing the behavior of a first rod 131 viewed from the second direction (Y) in the state of FIG. 16, and FIG. 18 is a schematic diagram showing the behavior of a third rod 133 viewed from the second direction (Y) in the state of FIG. 16.

Referring further to FIGS. 16 to 18, in this step (S132), the rods 130 may descend so as to horizontally overlap with at least some of the cargo items (B1, B2, B3, B4, B5, B6) (S132).

Specifically, one or more rods among the plural rods 131, 132, and 133, for example, the first rod 131, may descend in the third direction (Z) and be positioned to overlap with the first object B1 in the first direction (X).

At this time, the first rod 131 may overlap with the fourth object B4 in the third direction (Z), and during the descent of the end effector 100, the lower end of the first rod 131 may, at a certain moment, come into contact with the upper surface of the fourth object B4 and be pushed upward. In other words, the protruding length of the first rod 131 below the lower surface of the body plate 110 may be reduced.

In this state, the first rod 131 may be positioned to overlap with the first object B1 in the first direction (X) and to overlap with the fourth object B4 in the third direction (Z). Since this state has already been described with reference to FIG. 10 and the like, redundant explanation may be omitted for the interest of brevity.

In addition, when one or more rods among the plural rods 131, 132, and 133, for example, the second rod 132, may descend in the third direction (Z), and the second rod 132 and the second object B2 overlap in the third direction (Z), the lower end of the second rod 132 may come into contact with the upper surface of the second object B2 and be pushed upward at a certain moment during the descent of the end effector 100. In other words, the protruding length of the second rod 132 below the lower surface of the body plate 110 may be reduced.

In this state, the second rod 132 may be positioned to overlap with the second object B2 in the third direction (Z), and there may be no overlapping of cargo items with the second rod 132 in the horizontal direction. Since this state has already been described with reference to FIG. 10 and the like, redundant explanation may be omitted for the interest of brevity.

In addition, one or more rods among the plural rods 131, 132, and 133, for example, the third rod 133, may descend in the third direction (Z) and be positioned to overlap with the third object B3 in the first direction (X). In some embodiments, the third object B3 is placed on the sixth object B6, and the third rod 133 may partially overlap with the sixth object B6 in the first direction (X).

At this time, there may be no object overlapping with the third rod 133 in the third direction (Z), or at least no object interfering in the third direction (Z), and the third rod 133 may not be pushed upward. In other words, the protruding length of the third rod 133 below the lower surface of the body plate 110 may not be reduced and may remain substantially the same as its initial state.

In this state, the third rod 133 may be positioned to overlap with the third object B3 in the first direction (X). Since this state has already been described with reference to FIG. 10 and the like, redundant explanation may be omitted for the interest of brevity.

Next, the joint unit controller 313 may control the joint motor of the joint unit 200 to retract the end effector 100 toward the opposite side of the first direction (X) (S133).

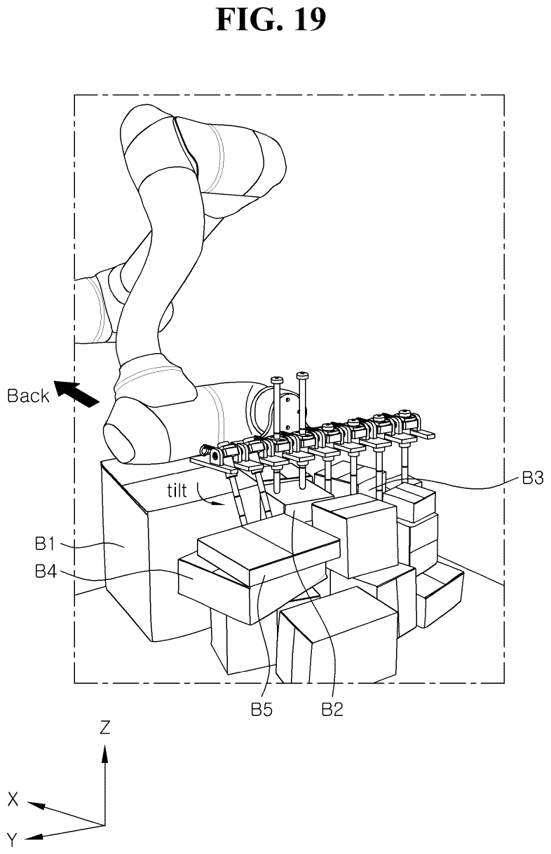

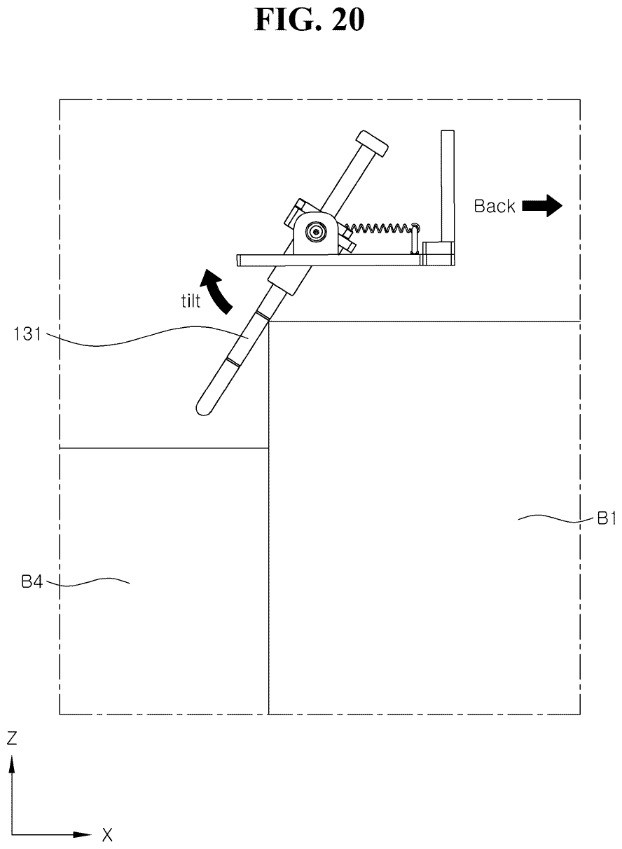

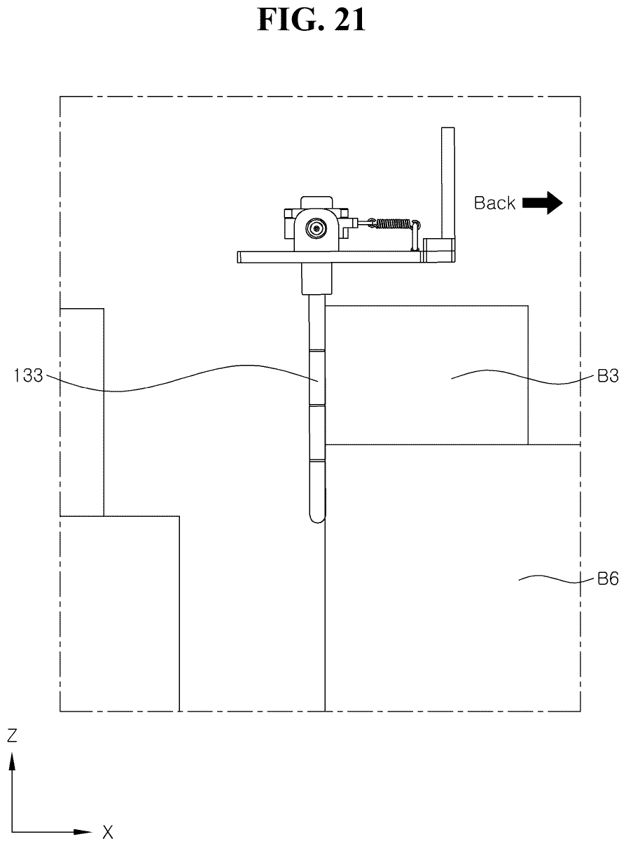

FIG. 19 is a schematic diagram illustrating a state in which the end effector 100 retracts while the lower end of the second rod 132 retracts along the upper surface of the second object B2. FIG. 20 is a schematic diagram illustrating the behavior of a first rod 131 viewed from the second direction (Y) in the state of FIG. 19, and FIG. 21 is a schematic diagram illustrating the behavior of a certain third rod 133 viewed from the second direction (Y) in the state of FIG. 19.

Referring further to FIGS. 19 to 21, as the end effector 100 retracts, one or more objects (the third object B3 and/or the sixth object B6) may be swept and pushed rearward in the first direction (X) due to interference with the rod 133, while a certain object (the first object B1) may not be pushed away despite interference with the rod 131.

Specifically, if a combined load associated with the individual weights of the third object B3 and the sixth object B6 and exerted on the third rod 133, is less than or equal to a reference load for tilting the rod 133, the third rod 133 may either maintain its initial state without substantially tilting, or it may tilt only slightly while still pushing the third object B3 and the sixth object B6 away.

On the other hand, if a load associated with a weight of the first object B1 and applied to each of the rods 130 is equal to or greater than the reference load allowed by each of the rods 130, each of the rods 130 may tilt rather than push the first object B1 away. For example, as shown in FIG. 19, if the reference load for tilting one rod is 3 kgf and two rods interfere with the first object B1, the two interfering rods (e.g., the first rods 131) may tilt together if a load applied by the first object B1 to each of the two interfering rods is equal to or greater than 3 kgf to make a total load applied to the two interfering rods equal to or greater than 6 kgf. Furthermore, as the first rod 131 tilts, the vector component of the action/reaction force between the first rod 131 and the first object B1 in the retraction direction of the end effector 100, i.e., the first direction (X), may gradually decrease, thereby naturally reducing the pushing force exerted by the first rod 131 on the first object B1.

Meanwhile, as previously described, the second rod 132 does not contribute to sweeping, i.e., cargo unloading, because there is no object overlapping and interfering with it in the first direction (X).

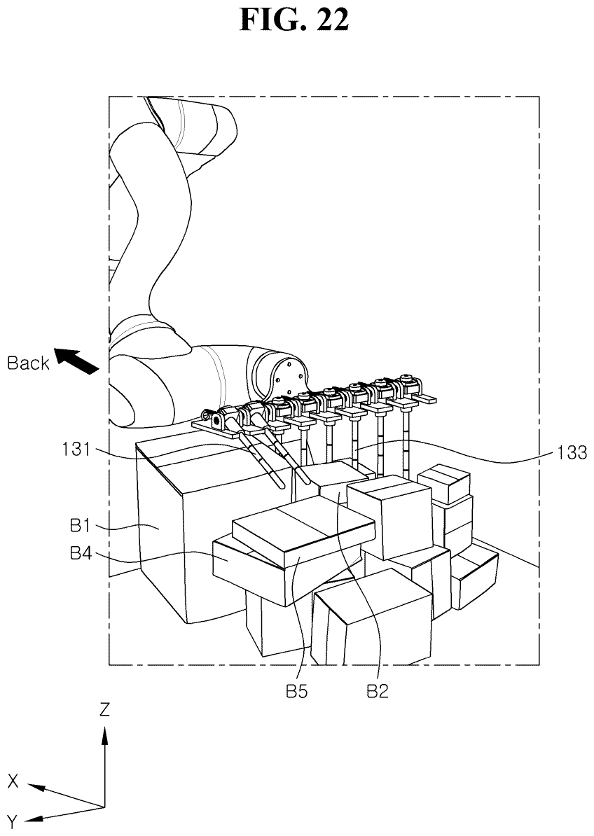

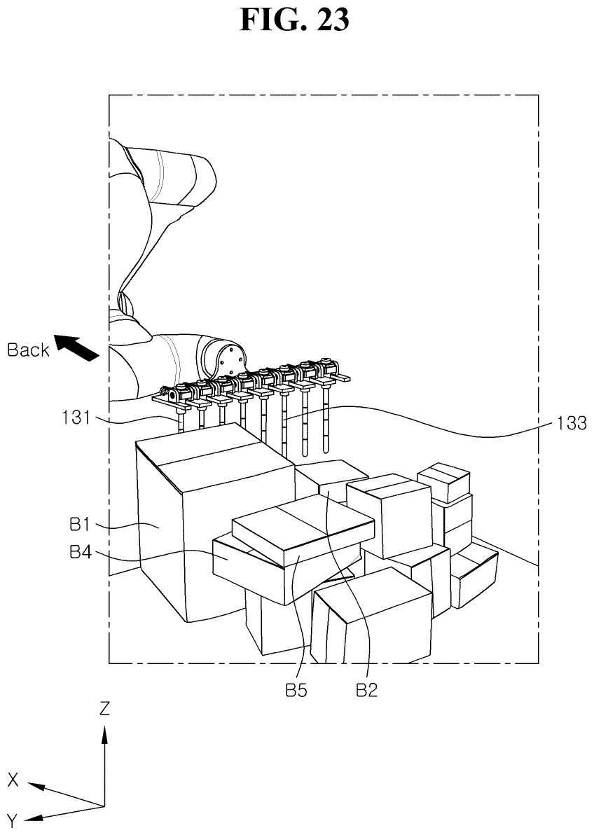

In this regard, FIG. 22 illustrates a state in which the end effector 100 has retracted further and the first rod 131 is tilted even more backward, and FIG. 23 illustrates a state in which the end effector 100 has retracted even further so that the first rod 131 moves to no longer overlap with the first object B1 in the third direction (Z). As a result, the horizontal force applied to the first rod 131 disappears, allowing the first rod 131 to sag again downward in the direction of gravity, and the third object B3 and the like are pushed off by the third rod 133.

As described above with reference to FIGS. 15 to 23, the end effector 100 includes the plural rods (or a plurality of rods) 130, and is configured such that the plural rods 130 may tilt independently of one another when a horizontal force exceeding a reference load acts on each of the rods 130, thereby preventing sweeping of objects that may be at risk of damage among the plurality of cargo items swept at once.

When unloading cargo composed of unstructured objects that are not aligned and have various sizes and weights, there may be objects whose weight makes them difficult to sweep using the rods 130. In such cases, if an object is forcibly swept, components such as the joint unit 200 of the robot device 10 may be damaged, or heavy cargo items(s) may suffer damage. Therefore, rather than forcibly sweeping the first object B1, the system may be configured to sweep selectively the third object B3 and the sixth object B6 in this step (try), and then reconfigure the work area so that more rods interfere with the relatively heavy first object B1, allowing a new sweeping attempt to be made.

In some embodiments, the detection part 319 may determine whether the end effector 100 is capable of retracting (S191). As described above, when a horizontal force exceeding or equal to a preset reference load is applied to each of the rods 130, the rods 130 may be configured to tilt. When the rods 130 tilt, the actual load applied to the rods 130 may gradually decrease despite the horizontal force, and if the rods 130 are fully tilted in the lateral direction, no load may be applied at all. In other words, the reference load (e.g., the first reference load) serves as a threshold for determining tilting of the rods 130 and may be mechanically designed based on the elasticity of the elastic member 195, the coupling structure, and so on. Once the rods 130 tilt, the action/reaction vector in the first direction (X) caused by the retraction of the end effector 100 decreases, thereby reducing the force applied to each of the rods 130. As a result, a load exceeding the reference load may not be applied to the rods 130, or to the elastic member 195 connected to restore the rods 130, or to the fixing structure 191 or load cell mechanically fixed with the elastic member 195. In other words, under conditions where tilting of the rods 130 is possible, the load applied to each of the rods 130 may decrease as they tilt, and thus, no load exceeding the first reference load may be applied to each of the rods 130, thereby substantially preventing damage to the robot device.

However, in an unloading environment where various irregularly shaped, sized, and weighted objects are stacked without alignment, interference with surrounding structures may result in a force exceeding the first reference load being applied to the rods 130, but smooth tilting may not occur. In such cases, the first reference load may be continuously applied, or the reduction in load due to tilting may not be sufficient.

Accordingly, the detection part 319 may be utilized to determine whether retraction is possible by measuring whether a load equal to or greater than a reference load (e.g., a second reference load) is applied to each of the rods 130 or to another component capable of measuring or estimating the load applied to the rods 130, such as a load cell. Here, the second reference load does not refer to the load at which tilting of the rods 130 begins, but rather to a threshold used to determine whether retraction is possible or has succeeded, and it may be a preset value for implementing the control method of the robot device 10. For example, the second reference load may be equal to or greater than the first reference load.

By way of non-limiting example, if it is determined that a force of 3.5 kgf (i.e., the second reference load) is applied to any of the rods 130 as a result of the retraction movement step (S133) of the end effector 100 or thereafter even if each of the rods 130 of the end effector 100 is mechanically designed to tilt when a load of 3 kgf (i.e., the first reference load) or more is applied, it may be determined that retraction is not possible, or that the retraction step (S133) should be terminated.

If it is determined that retraction is not possible, the joint unit controller 313 may perform the previously described steps in reverse order. For example, a process of moving the end effector 100 upward may be performed, and it may return to the initial posture control step (S100).

On the other hand, if it is determined that the force applied to each of the rods 130 does not exceed the second reference load and that the retraction of the end effector 100 has been successful, the detection part 319 may determine the position state of the rods 130 in the third direction (Z) (S192).

As described above, the rods 130 may be pushed upward due to interference with the upper end of the cargo. If the end effector 100 retracts while the rods 130 are in the upwardly moved state (S133), the interference with the cargo that pushed the rods 130 upward disappears, and the external force applied in the upward third direction (Z) is removed. As a result, the rods 130 should sag again due to gravity. However, for some reason, the rods 130 may remain in the upwardly moved state without sagging. In such a state, even if an unloading operation is performed again, efficient unloading, i.e., sweeping, may not be achieved.

Alternatively, if the end effector 100 retracts while the rods 130 are in a tilted state (S133), the rods 130 should sag again due to gravity as the horizontal force applied to them is removed. However, for some reason, the rods 130 may not sag and may remain in the tilted state. In such a state, even if an unloading operation is performed again, normal unloading may not be achieved due to interference caused by the tilted rods.

To this end, the detection part 319 may determine whether the rods 130 have normally moved downward in a vertical linear manner after the retraction movement step (S133), or whether the tilted state of the rods 130 has been released (S192). If it is determined that the rods 130 have sagged properly, the previous process may be repeated. On the other hand, if it is determined that the rods 130 have not sagged properly, an alert may be provided to a user, or the end effector 100 may be shaken to apply an external force that allows the rods 130 to move downward due to gravity and release the tilted state.

Although not illustrated in the drawings, the end effector 100 may include a sensor capable of detecting the vertical position of the rods 130 for performing the step (S192). By way of non-limiting example, the sensor may be provided on the upper part of the hinge block 153 and implemented in a manner such as measuring the distance to the rod head 130a or detecting contact. In some other embodiments, the end effector 100 may further include a sensor capable of detecting the degree of tilt of the rods 130. As a non-limiting example, an optical sensor may be used as the sensor for performing the present step (S192).

Hereinafter, other embodiments of the present disclosure will be described. However, descriptions of configurations and/or functions that are similar to those of the above-described embodiments may be omitted for the interest of brevity.

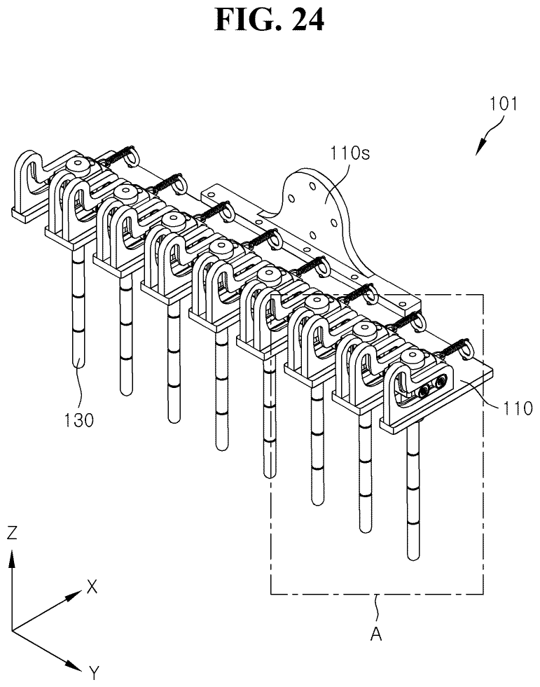

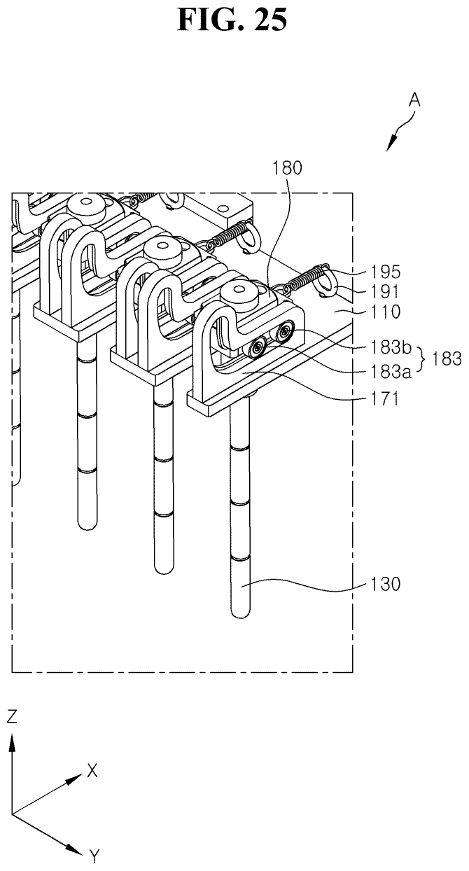

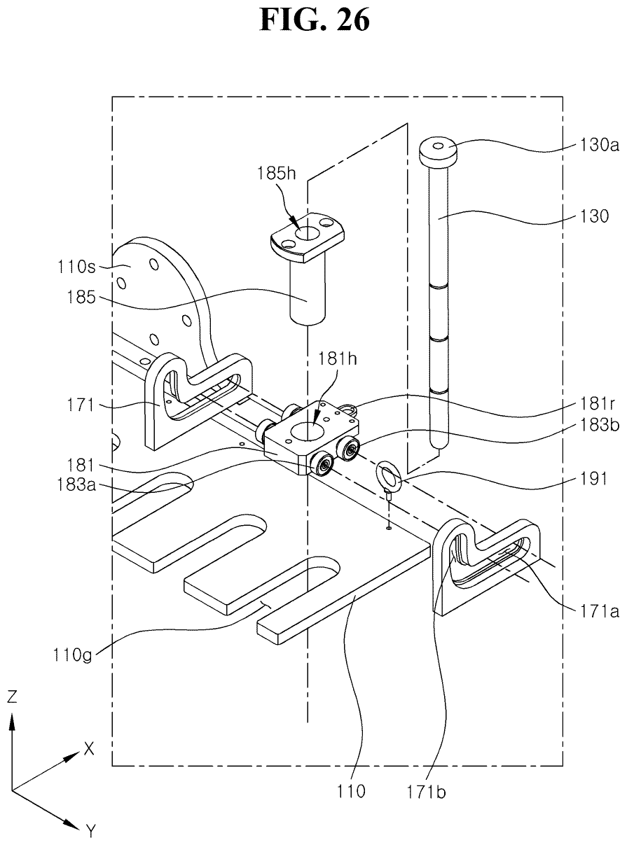

FIG. 24 illustrates the perspective view of an end effector according to another embodiment of the present disclosure. FIG. 25 illustrates the enlarged view of a region A of FIG. 24. FIG. 26 illustrates the exploded perspective view of the end effector of FIG. 25.

Referring to FIGS. 24 to 26, the end effector 101 of the robot device according to an embodiment includes the body plate 110 and the rods 130 mechanically coupled to the body plate 110, and is distinguished from the robot device and its end effector of the above-described embodiment in that it further includes a guide rail 171 and a carriage 180. Accordingly, the rods 130 may be configured to move, at least partially, in a horizontal direction (e.g., a transverse direction of the body plate 110) along the guide rail 171, rather than rotating about a hinge axis. As previously described, the robot device including the end effector 101 may further include a joint unit, a processor, and the like.

The guide rail 171 may be fixedly disposed on the upper surface of the body plate 110. A pair of guide rails 171 may be provided, and spaced apart in a longitudinal direction of the body plate 110 (e.g., the second direction (Y)) with one plate groove 110g interposed therebetween in a planar view.

The guide rail 171 may provide a slit-type rail. The guide blocks 183 of the carriage 180, which will be described later, may be inserted into the slit of the guide rail 171 to define the movement path of the carriage 180. Specifically, the guide rail 171 or the slit of the guide rail 171 may have a bent structure, not a straight slit, including a first rail part (or a first slit) 171a extending in one direction (e.g., approximately the first direction (X)) and a second rail part (or a second slit) 171b extending in another direction (e.g., approximately the third direction (Z)). For example, the first slit 171a may extend in a transverse direction (e.g., the first direction X in FIG. 25) of the body plate 110, and the second slot 171b may extend in a thickness direction (e.g., the third direction Z in FIG. 25) of the body plate 110. Additionally, a curved third rail part (or a curved third slit) connecting the first rail part 171a and the second rail part 171b, which extend in different directions, may be further included. The second rail part 171b may be connected to one end of the first rail part 171a on one side in the first direction (X). In another embodiment, the second rail part 171b may not extend in the third direction (Z), but may extend in a non-parallel direction to the third direction (Z) while intersecting the first direction (X) within the plane defined by the first direction (X) and the third direction (Z).

That is, when the guide blocks 183 are inserted into the first rail part 171a, the carriage 180 may move in the first direction (X), and when the guide blocks 183 are inserted into the second rail part 171b, the carriage 180 may move in the third direction (Z).

In the initial state, for example, in a state where the carriage 180 is pulled by the elastic member 195 as will be described below, all or some of the guide blocks 183 of the carriage 180, for instance at least two guide blocks 183a and 183b, may be positioned within the first rail part 171a and may not be located within the second rail part 171b.

The carriage 180 may include a moving plate 181 (also referred to as a moving block or a transport member) and at least two guide blocks 183, and may further include a bushing member 185 and a fixed end 181r.

The moving plate 181 may have a rod hole 181h. The rod hole 181h may penetrate the moving plate 181 in the third direction (Z), and each of the rods 130 may be at least partially inserted into the rod hole 181h.

The bushing member 185 may be coupled to the moving plate 181. As previously described, each of the rods 130 may vertically and linearly move in the upward and downward directions of the third direction (Z) while being inserted into the moving plate 181. Therefore, the bushing member 185, such as a linear bushing, may be provided to assist the linear movement of the rods 130. Specifically, the bushing member 185 may be at least partially inserted into the rod hole 181h of the moving plate 181, and each of the rods 130 may be inserted into the bushing hole 185h of the bushing member 185.

On a side of the moving plate 181, the guide blocks 183 including a first guide block 183a and a second guide block 183b may be disposed. Here, the first guide block 183a and the second guide block 183b may be spaced apart from each other in the first direction (X). FIG. 26 and the like illustrate a case where a pair of first guide blocks 183a are spaced apart in the second direction (Y) and disposed on opposite sides of the moving plate 181, respectively, and a pair of second guide blocks 183b are also spaced apart in the second direction (Y) and disposed on the opposite sides of the moving plate 181, respectively, resulting in a total of four guide blocks 183. Also, one of the pair of first guide blocks 183a and a corresponding one of the pair of second guide blocks 183b are arranged in the first direction (X).

The guide blocks 183, including the first guide block 183a and the second guide block 183b, may be inserted into the slit provided by the guide rail 171, i.e., the first rail part 171a, the second rail part 171b, and the third rail part, and may roll or slide along the extending direction. As a non-limiting example, the guide blocks 183 may have an approximately circular shape and may be implemented using bearings or the like, although embodiments of the present disclosure are not limited thereto.

In some embodiments, the end effector 101 may further include an elastic member 195 and a fixing structure 191 for securing the elastic member 195. The elastic member 195 may be in a contracted state in its initial condition, and may be extended in length by an external force, and when the external force is removed, it may contract back to its initial state or to a state close thereto. An example of the elastic member 195 may be a spring or the like.

One end of the elastic member 195 may be coupled to the fixed end 181r of the carriage 180, and the other end of the elastic member 195 may be fixed on the body plate 110. FIG. 25 and the like illustrate a case in which an eye bolt is provided as the fixing structure 191, and the other end of the elastic member 195 is coupled and fixed to the fixing structure 191. As previously described, the fixing structure 191 may incorporate a load cell or may be provided with a load cell capable of measuring the tensile force applied to the elastic member 195 coupled to the fixing structure 191.

In the end effector 101 according to the embodiment of FIG. 24, each of the rods 130 may be inserted into the carriage 180, specifically into the rod hole 181h of the moving plate 181, and may linearly move in the third direction (Z). That is, the protruding length of the rods 130 from one surface of the body plate 110 may be variable. Since the structure and function of the freely coupled connection between the rods 130 and the body plate 110, as well as the variation in protruding length caused by gravity and other external forces, have been described in detail with the above-described embodiments, redundant explanation may be omitted for the interest of brevity.

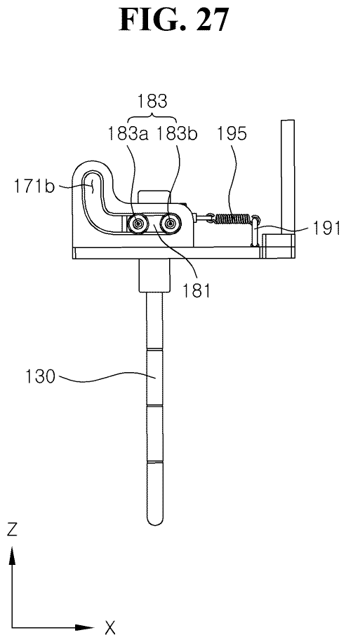

Furthermore, each of the rods 130 may be tilted by means of the guide rail 171, which includes rails extending at least partially in different directions, i.e., the first rail part 171a and the second rail part 171b, and the carriage 180. Hereinafter, the tilting process of each of the rods 130 will be described with further reference to FIGS. 27 to 29.

FIGS. 27 to 29 are schematic diagrams illustrating the tilting process of the rod of the end effector according to the embodiment of FIG. 24, and are supplementary views illustrating the end effector of FIG. 25 as viewed from the side.

Referring further to FIG. 27, in the initial state, the first guide block 183a and the second guide block 183b of the carriage 180 are positioned within the first rail part 171a of the guide rail 171, and the rods 130 may be in a sagging state generally in the third direction (Z), i.e., downward in the direction of gravity. That is, the first guide block 183a and the second guide block 183b are at substantially the same height, the moving plate 181 is placed approximately horizontally, and each of the rods 130 inserted into the moving plate 181 may face downward substantially in the direction of gravity. In addition, the elastic member 195 may be in a substantially fully contracted state and may restrict the movement of the carriage 180.

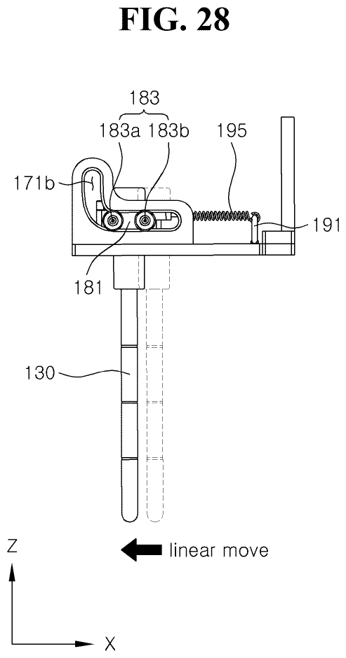

Referring further to FIG. 28, if a horizontal force is applied to a certain position of the rod 130, specifically in a horizontal direction at some point along their extension direction (the third direction (Z)), the rod 130 and the carriage 180 into which the rod 130 is inserted may linearly move together in the horizontal direction (e.g., a direction opposite to the first direction (X)). FIG. 28 illustrates a case in which the rods 130 have moved horizontally without tilting compared to the initial state. That is, in the state shown in FIG. 28, both the first guide block 183a and the second guide block 183b may be positioned within the first rail part 171a. For example, when the first guide block 183a and the second guide block 183b are positioned in the first slit 171a, the carriage 180 and the rod 130 linearly move together in the first direction X.

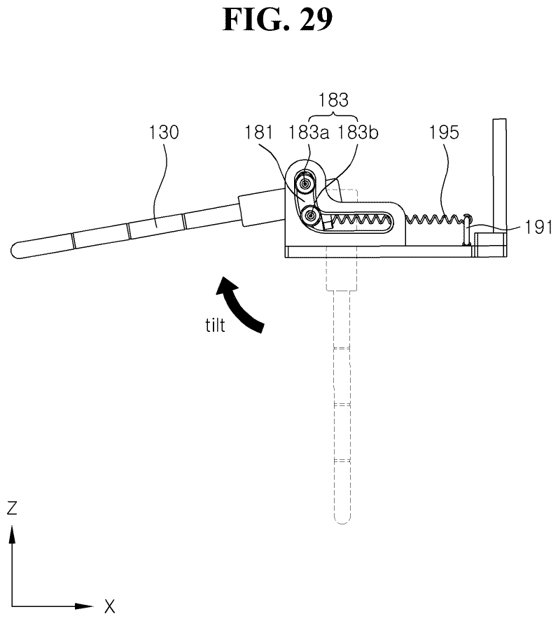

Referring further to FIG. 29, if a horizontal force sufficient to extend the elastic member 195 is continuously applied to a certain position of the rods 130, the rods 130 and the carriage 180 into which the rods 130 are inserted may move along the curved rail part (a third rail part) connecting the first rail part 171a and the second rail part 171b, as well as along the second rail part 171b. At this time, since the first rail part 171a and the second rail part 171b extend in different directions, the carriage 180 transporting the rods 130 may move in a direction different from the extension direction of the first rail part 171a (i.e., the first direction (X)). Accordingly, the extension direction of the rods 130 inserted into the carriage 180 may become tilted in a direction intersecting the third direction (Z). Specifically, one or both of the first and second guide blocks 183a and 183b are positioned in the second slit 171b, a corresponding rod 130 (e.g., the rod 130 connected to the guide blocks 183a and 183b via the moving plate 181) may be tilted.

FIG. 29 illustrates a case in which the first guide block 183a is positioned within the second rail part 171b, and the second guide block 183b is located approximately within the third rail part. However, embodiments of the present disclosure are not limited thereto. For example, the first guide block 183a may be positioned within the second rail part 171b while the second guide block 183b is positioned within the first rail part 171a, or the second guide block 183b may also be positioned within the second rail part 171b.

In the present specification, the terms “tilted” or “tilting” refer not only to tilting caused by rotation about a certain point, but also include cases where the tilt occurs as a result of horizontal movement followed by rotation, or as a result of motion including curved movement, compared to the initial state.

Meanwhile, if the horizontal force disappears, or if the rods 130 become tilted as shown in FIG. 29 and the horizontal force is no longer sufficiently transmitted to the rods 130 (in other words, if the external force applied to the rods 130 is removed or only a force smaller than the restoring force of the elastic member 195 is applied), the carriage 180 may return to its initial position along the guide rail 171 by the restoring force of the elastic member 195, and the extension direction of the rods 130 may be restored to the third direction (Z).

In the end effector 101 according to the embodiment of FIG. 24, the carriage 180 into which each of the rods 130 is inserted includes at least two guide blocks 183, namely the first guide block 183a and the second guide block 183b, and the guide blocks 183 may move along the first rail part 171a so that even when a force is applied to a corresponding one of the rods 130, rotation about a single point does not occur, and instead, horizontal movement is possible. That is, the horizontal force does not act as a torque but may contribute to the horizontal movement of the carriage 180.

After the horizontal movement, one or more of the plural guide blocks 183, e.g., the first guide block 183a, may perform a curved motion along the third rail part and the second rail part 171b, and as the first guide block 183a and the second guide block 183b are positioned at different heights in the third direction (Z), the rod 130 and the carriage 180 may consequently be tilted.

In other words, starting from the state shown in FIG. 27 in which no external force is applied, a horizontal force may be applied, and through the state shown in FIG. 28, where both the first guide block 183a and the second guide block 183b are positioned within the first rail part 171a, to the state shown in FIG. 29 in which the first guide block 183a has entered the second rail part 171b, the rod 130 and the carriage 180 may, during at least part of this process (i.e., the transition from FIG. 27 to FIG. 28), move horizontally in a direction opposite to the first direction (X).

As described with the above-described embodiments, the end effector 101 according to such embodiments may control the reference load required to tilt the rods 130 by utilizing the elasticity and attachment position of the elastic member 195. The reference load for tilting the rods 130 may be an important factor in preventing damage to the robot device and the cargo.

If, unlike in embodiment of FIG. 24, the rod 130 is tilted by rotating about a single point, the actual force acting to tilt the rod 130 may vary depending on the position where the horizontal force is applied, due to the principle of leverage. For example, when a horizontal force is applied to a lower portion of the rod 130, a relatively large torque may be generated about the rotational axis due to the lever principle even if the horizontal force is smaller than the reference load, and the rods 130 may become tilted. Conversely, when a horizontal force is applied to an upper portion of the rod 130, a relatively small torque may be generated about the rotational axis due to the lever principle even if the horizontal force is greater than the reference load, and the rod 130 may not become tilted.

That is, differences in the longitudinal position at which a horizontal force is applied to the rods 130, and the resulting action of the lever principle, may lead to unintended tilting or failure to tilt, even when a reference load has been set. However, as in the embodiment of FIG. 24, during a certain process in which the rod 130 is tilted from the initial state, particularly immediately after the horizontal force is applied, the system is configured so that the rods 130 and the carriage 180 transporting the rods 130 perform a horizontal linear movement. This substantially prevents an occurrence of unintended tilting or failure to tilt, and implements reliable tilting according to the set reference load.

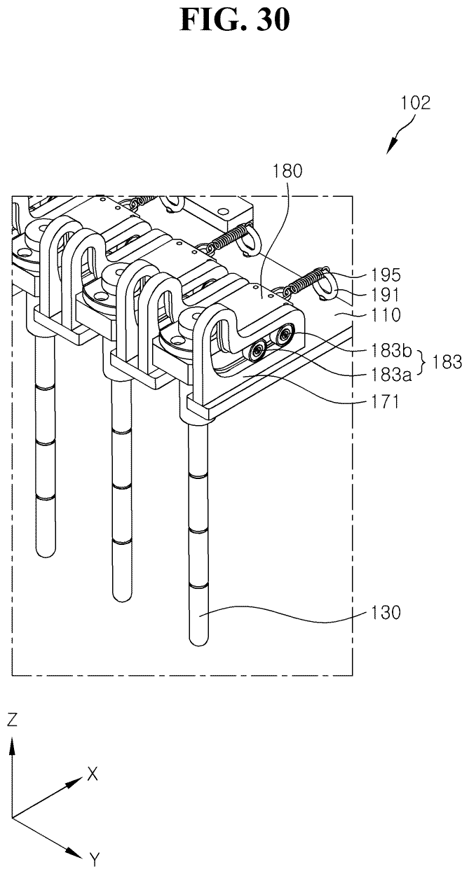

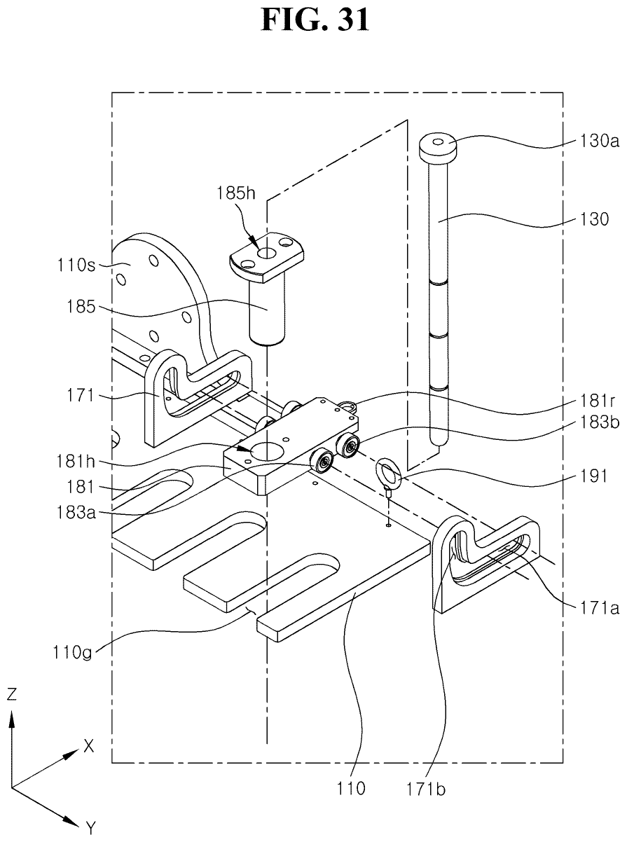

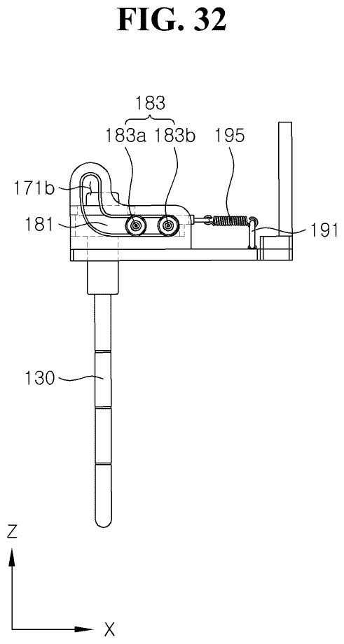

FIG. 30 is the enlarged view of a portion of the end effector according to another embodiment of the present disclosure. FIG. 31 is the exploded perspective view of the end effector of FIG. 30. FIG. 32 is the side view of the end effector of FIG. 30.

Referring to FIGS. 30 to 32, an end effector 102 of the robot device includes a body plate 110, a rod 130, a guide rail 171, and a carriage 180, but differs from the robot device and end effector of the embodiment of FIG. 24 in that guide blocks 183 of the carriage 180 are positioned offset toward the opposite side of the first direction (X). As previously described, the robot device including the end effector 102 according to the embodiment of FIG. 30 may further include a joint unit, a processor, and the like.

The carriage 180 includes a moving plate 181, a first guide block 183a and second guide block 183b disposed on one side of the moving plate 181 in the second direction (Y), and, as previously described, has a rod hole 181h penetrating the moving plate 181 in the third direction (Z).

In this case, the first guide block 183a and the second guide block 183b may be positioned offset toward the opposite side in the first direction (X) (the upper-right direction in FIG. 30). For example, among the plural guide blocks disposed on one side of the moving plate 181 in the second direction (Y), the guide block located on the one side in the first direction (X) may be referred to as the first guide block 183a, and the guide block located on the opposite side in the first direction (X) may be referred to as the second guide block 183b. In such a case, a first distance from the first guide block 183a (e.g., a center of the first guide block 183a) to a first end surface of the moving plate 181 may be significantly greater than a second distance from the second guide block 183b to a second end surface of the moving plate 181, where the first and second end surfaces are arranged in the first direction (X) to face each other. By way of non-limiting example, the first distance may be at least twice, three times, or even four times greater than the second distance.

In addition, the center point between the plural guide blocks, for example, the center point between the first guide block 183a and the second guide block 183b in a planar view including the first direction (X) and the third direction (Z), may be located on the opposite side in the first direction (X) relative to the position of the rods 130 or the rod hole 181h (e.g., the center of the rod hole 181h). For example, where the first and second end surfaces of the moving plate 181 are arranged in the first direction (X) to face each other, a first distance in the first direction (X) between the first end surface and the center point between the first and second guide blocks 183a and 183b may be greater than a second distance in the first direction (X) between the second end surface and the center point.

In a more specific embodiment, the position of the first guide block 183a, which is located on one side in the first direction (X) among the plural guide blocks, may be located on the opposite side in the first direction (X) relative to the position of the rods 130 or the rod hole 181h.

Meanwhile, in the initial state where no external force is applied to the rods 130, both the first guide block 183a and the second guide block 183b are inserted and positioned within the first rail part 171a, as previously described. In the initial state, and in a planar view including the first direction (X) and the third direction (Z), each of the rods 130 may at least partially overlap with the second rail part 171b.

While some of embodiments of the present disclosure have been described above with reference to the drawings of the present disclosure, they are merely illustrative and not intended to limit various embodiments of the present disclosure. Those skilled in the art to which the present disclosure pertains will understand that various modifications and applications are possible.

Therefore, the scope of various embodiments of the present disclosure should be understood to include modifications, equivalents, or substitutions of the technical concepts exemplified above. For example, each component specifically described in the embodiments of the present disclosure may be implemented with variations. Such modifications and applications should be interpreted as falling within embodiments of the present disclosure.

1. An effector, comprising:
a body plate; and
at least one rod coupled to the body plate,
wherein the at least one rod is configured to be variably tilted with respect to the body plate.

2. The effector according to claim 1, wherein the body plate has a groove extending in a transverse direction of the body plate, and the rod is disposed in the groove.

3. The effector according to claim 1, wherein the rod is directly or indirectly freely coupled to the body plate so as to make the rod be tilted with respect to the body plate by gravity or an external force.

4. The effector according to claim 3, wherein the rod is provided as a plurality of rods, and the plurality of rods are configured to be tilted independently of one another.

5. The effector according to claim 1, wherein the end effector is included in a robot device for cargo unloading, and
wherein the rod is provided as a plurality of rods, and one or more of the plurality of rods are configured to be insertable into corresponding gaps between individual cargo items located at an upper end portion of the cargo.

6. The effector according to claim 1, further comprising:
a guide rail disposed on the body plate; and
a carriage configured to be movable along the guide rail and having a rod hole into which the rod is inserted.

7. The effector according to claim 6, wherein the guide rail comprises a first slit extending in a first direction, and a second slit extending in a third direction and coupled to the first slit.

8. The effector according to claim 7, wherein the carriage comprises a plurality of guide blocks engaged with the guide rail, and the plurality of guide blocks comprises a first guide block and a second guide block inserted into the guide rail,
wherein the carriage and the rod are configured to linearly move together in the first direction, when the first guide block and the second guide block are both positioned in the first slit, and
wherein the rod is configured to be tilted, when one or both of the first guide block and the second guide block are positioned in the second slit.

9. The effector according to claim 6, wherein the body plate has a groove extending in a transverse direction of the body plate, and
wherein the carriage is configured to be at least partially linearly movable in the transverse direction while moving along the guide rail.

10. The effector according to claim 6, further comprising an elastic member fixed to the body plate and the carriage.

11. The effector according to claim 1, wherein during tilting of the rod, the rod is configured to be at least partially linearly movable in a direction intersecting an extension direction of the rod.

12. The effector according to claim 1, wherein the effector is included in a robotic device that comprises a joint arm configured to move the effector, and the effector is coupled to an end portion of the joint arm.

13. A robot device, comprising:
an end effector;
a joint arm coupled to the end effector and configured to move the end effector; and
a processor configured to execute a program stored in a memory so as to control movement of the end effector,
wherein the processor is configured to:
acquire cargo image information;
control the joint arm to perform a first movement so as to move the end effector above a cargo elevation, the end effector including a body plate and at least one rod;
control the joint arm to perform a second movement so as to move the end effector downward after the first movement; and
control the joint arm to perform a third movement so as to retract the end effector after the second movement.

14. The robot device according to claim 13, wherein the processor is configured to maintain a vertical position of the body plate during the third movement substantially same as that of the body plate at the end of the second movement.

15. A method of operating a robot device for unloading cargo, wherein the robot device comprises a body plate and at least one rod coupled to the body plate, the method comprising:
moving the rod above loaded cargo items;
moving the end effector downward; and
retracting the end effector.

16. The method according to claim 15, wherein the at least one rod is a plurality of rods, and one or more of the plurality of rods are inserted between boundaries of adjacent ones of the cargo items as a result of the moving of the end effector downward, or the retracting of the end effector, or both.

17. The method according to claim 15, wherein during the retracting of the end effector, a lower end of the rod retracts while being in contact with an upper surface of a corresponding one of the cargo items.

18. The method according to claim 15, wherein the at least one rod is a plurality of rods, and one or more of the plurality of rods are tilted during the retracting of the end effector.

19. The method according to claim 15, wherein the at least one rod is a plurality of rods, and during the retracting of the end effector, one or more of the plurality of rods move in a horizontal direction.

20. The method according to claim 15, wherein as a result of the retracting of the end effector, one or more of the cargo items are swept and unloaded by the rod.
